(19) United States
(12) Patent Application Publication
(10) Pub. No.: US 2021/0192617 A1
(43) Pub. Date: Jun. 24, 2021

(54) BASKET PRICING AT CLIENT

(71) Applicant: CFPH, LLC, NEW YORK, NY (US)

(72) Inventors: Kevin Foley, NEW YORK, NY (US); Lawrence Tint, NEW YORK, NY (US)

(21) Appl. No.: 17/108,989

(22) Filed: Dec. 1, 2020

Related U.S. Application Data
(63) Continuation of application No. 14/849,153, filed on Sep. 9, 2015, now abandoned.
Application No. 14/849,153 is a continuation-in-part of application No. 13/844,779, filed on Mar. 15, 2013, now abandoned.
Application No. 13/844,779 is a continuation-in-part of application No. 13/234,147, filed on Sep. 15, 2011, now abandoned.
(60) Provisional application No. 61/383,081, filed on Sep. 15, 2010.
(60) Provisional application No. 61/513,667, filed on Jul. 31, 2011.
(60) Provisional application No. 61/612,958, filed on Mar. 19, 2012.
(60) Provisional application No. 61/614,245, filed on Mar. 22, 2012.
(60) Provisional application No. 62/047,651, filed on Sep. 9, 2014.
(60) Provisional application No. 61/614,245, filed on Mar. 22, 2012.
(60) Provisional application No. 61/612,958, filed on Mar. 19, 2012.

(51) Int. Cl. G06Q 40/04

(52) U.S. Cl. CPC G06Q 40/04

(57) ABSTRACT

Various embodiments are directed to a trading system and method for determining orders and their prices. A trader may request a quote for a composite order comprising a plurality of constituent orders. The request may be provided to a pricing module located behind the trader's firewall. The pricing module may determine a quote on behalf of a pricing entity associated with a fund. The quotes may be determined based on current market conditions and net tracking error that would result if the fund executed all of the constituent orders of the composite trading order. The trading module may provide the requesting trader with the requested quote, which may comprise a firm counter-order immediately executable against the composite trading order. The quote and the existence of the request may not be transmitted outside the trader's firewall. The trader may execute the quote, and the pricing entity may fill all the constituent trading orders of the trader's composite trading order at the quoted price(s).

### CROSS-REFERENCE TO RELATED APPLICATIONS

This application is a continuation of U.S. patent application Ser. No. 14/849,153 filed Sep. 9, 2015 which is a continuation-in-part of U.S. application Ser. No. 13/844,779 filed Mar. 15, 2013, which claims the benefit of U.S. Provisional Application No. 61/612,958 filed Mar. 19, 2012, entitled “ORDER PRICING BASED ON MARKET IMPACT,” and U.S. Provisional Application No. 61/614,245 filed Mar. 22, 2012, also entitled “ORDER PRICING BASED ON MARKET IMPACT,” and which is a continuation-in-part of U.S. application Ser. No. 13/234,147 filed Sep. 15, 2011, entitled “SYSTEMS AND METHODS FOR ORDER PRICING,” which claims the benefit of U.S. Provisional Patent Application Ser. No. 61/513,667 filed Jul. 31, 2011, entitled “SYSTEMS AND METHODS FOR PRICING ORDERS,” and U.S. Provisional Application No. 61/383,081 filed Sep. 15, 2010, entitled “SYSTEMS AND METHODS FOR ORDER PRICING.” This application also claims the benefit of U.S. Provisional Application. No. 62/047,651 filed Sep. 9, 2014, entitled “BASKET PRICING AT CLIENT.” The disclosures of each of the above applications are incorporated herein by reference in their entireties.

### BACKGROUND

Trading parties typically submit trading orders for a security at prices and quantities they are willing to trade. The prices and quantities they are willing to trade for a particular security may depend on various factors.

Various systems enable users to submit trading orders or requests for trading orders that are shown to a plurality of counter-parties. The orders may have different prices and quantities, and may be submitted so that a counter-party does not know the identity of the trader submitting the order or request. For example, U.S. patent application Ser. No. 10/310,345 (U.S. Patent Publication No. 2004/0034591) describes a system that sends anonymous trading messages from one party to a targeted group of counter-parties.

### BRIEF SUMMARY

Various embodiments are directed to pricing one or more trading products based on one or more factors, such as the effect the purchase and/or sale of the trading products would have on a trading counterparty.

### BRIEF DESCRIPTION OF THE FIGURES

FIG. 1 depicts a system according to at least one embodiment of the systems disclosed herein;

FIG. 2 depicts a flow diagram according to at least one embodiment of the methods disclosed herein.

FIG. 3 depicts a flow diagram according to at least one embodiment of the methods disclosed herein.

FIG. 4 depicts an exemplary system architecture according to at least one embodiment of the systems disclosed herein;

FIGS. 5-6 illustrate information related to examples of noise trading, according to at least one embodiment of the systems and methods disclosed herein.

FIGS. 7-10 illustrate information related to examples of reservation price trading, according to at least one embodiment of the systems and methods disclosed herein.

FIG. 11 depicts a flow diagram according to at least one embodiment of the methods disclosed herein.

FIG. 12 depicts a flow diagram according to at least one embodiment of the methods disclosed herein.

### DETAILED DESCRIPTION

The following section I provides a guide to interpreting the present application.

### I. Other Definitions

Below are various financial definitions that may be used as a guide for understanding these terms as used in this application. These terms are from Finance, Market Data, Futures Trading, Cantor Comparative Advantage (“CCA”), and Aqua ATS. It should be appreciated that CCA can Aqua ATS are exemplary entities (e.g., companies) that provide trading-related products and services. As used herein, CCA may comprise server 2. In some embodiments, CCA may comprise system 100.

“Security” means a fungible, negotiable equity or debt instrument that represents monetary value. E.g., stocks and bonds.

“Index” means a set of stocks and respective weights for each stock where the weighted average of the prices of those stocks serves as an indicator or benchmark for more generic stock price movements.

“Portfolio” means a collection of securities, cash and/or other holdings.

“Fund” means a portfolio managed by a professional investment company and offered to its investors. As used herein, the term “fund” may also refer to systems, processors, and other elements that act on behalf of the fund, e.g., by identifying orders, generating orders, calculating prices, submitting orders, executing orders, and determining other fund-related information. For example, a “fund” may refer to a system that manages a fund.

“Mutual Fund” means a fund that enables investors to pool their money with other investors.

“Index Fund” means a fund that's designed to mirror the performance of an index.

“S&P 500 Index” means an index of the 500 most widely held U.S. stocks weighted by market capitalization. Stocks are selected by the Standard & Poors Index Committee to be most representative of the U.S. stock market.

“NAV” means “Net Asset Value,” which means the market value of a fund. NAV per share is calculated by most funds by taking the closing price of all securities owned plus all other assets such as cash, subtracting all liabilities, then dividing the result (total net assets) by the total number of shares outstanding.

“Cash Drag” means the cash portion of a fund that, all else equal, can result in an index fund underperforming its positively performing benchmark (if trading costs are high enough, a “transaction cost drag” of continuous trading in an attempt to maintain cash at zero could exceed a cash drag). Higher cash levels imply higher cash drag.

“Benchmark” means An index that serves as a comparative measure for the performance of the fund. For example, the S&P 500 index is the benchmark for performance of many funds with domestic U.S. market exposure.

“Alpha” means a measure of a portfolio's return in excess of a risk-adjusted benchmark return; it is the amount by which an investor could “beat” a buy-and-hold investment with equivalent risk.

“Tracking Error.” Predicted tracking error on a given day may be given by:

(w−wB)′V(w−wB)
where:
w is the vector of portfolio weights,
wB is the vector of market weights, and
V is the day-t prediction of the variance covariance matrix among securities on day t.

Predicted tracking error is a measure of the variability of the portfolio return relative to the benchmark return; assuming that the tracking error prediction is accurate, the higher the tracking error, the higher the risk that the portfolio return may be below the benchmark. For a given alpha expectation for the portfolio, CCA and/or Aqua would like to have the predicted tracking error as small as possible (since that minimizes its risk of underperforming the benchmark).

Realized tracking error for a portfolio over a period of time, say a month, is the standard deviation of the differences between say the day-to-day return on the portfolio and the return on the benchmark during that month. The more accurate the predicted tracking error, the closer it is on average to realized tracking error.

In some embodiments, calculations of “tracking error” and other errors may account for information such as current trading conditions, recent news (e.g., news concerning the economy), financial news (e.g., earnings calls or reports for a company), and other information and events that may affect a trading price. For example, the system may account for the fact that prices for a stock may change rapidly based on information from an earnings call concerning the company issuing the stock (or a related stock).

In various embodiments of the present invention, the “tracking error” described in U.S. Ser. No. 12/477,549 filed Jun. 3, 2009 and U.S. Ser. No. 12/477,523 filed Jun. 3, 2009 may be used, e.g., alternatively or in addition to that described herein.

“NBBO,” or “National Best Bid and Offer,” means the highest published bid price and lowest published offer price for a U.S. equity security across all publicly quoted execution destinations where the security trades.

“Level 1” means the NBBO and trades for a U.S. equity security across all publicly quoted execution destinations where the security trades.

“Level 2” means the collection of best bid and offer sizes for tiers of order prices for a U.S. equity security provided by some or all publicly quoted execution destinations where the security trades. Sometimes referred to as market depth.

“Open Interest” means the sum of all long or short futures contracts in one delivery month in one market that have been entered into and not yet liquidated by an offsetting transaction or fulfilled by delivery.

“Quantal” means a San Francisco-based financial software and services company that provides portfolio risk management products for its clients. Quantal is an exemplary provider of products and services that may be used in conjunction with various features and embodiments described herein. It should be appreciated that for many features described herein, other products and services (e.g., provided by other companies) may be used.

“Quantal Model” means a risk-based equity trading model developed by Quantal. CCA may run the model for its customers to generate revenue that may be shared between itself, its customers, its customers' investors and Quantal.

“Customer” means an investment company that enters into a business arrangement with CCA to offer its investors the opportunity to allocate portions of their fund investments to CCA for trading via the Quantal model. The customer may receive a portion of the revenue generated in these investments by the model.

“Investor” means an investor in one of the funds to which the customer has allocated of portion to CCA for trading via the Quantal model. The investor may receive a portion of the revenue generated by trading in his fund according to the indications from the model.

“Fund” means the collection of all stocks and cash that a Customer gives to CCA to invest. Note that CCA maintains one or more funds per customer.

“Micro Cap” means any company whose outstanding shares have a dollar value less than a particular predetermined amount. In some embodiments, Aqua minimum order size for micro caps may be a predetermined number of shares (such as 2k, 5, 10k, 20k) and the shot clock may be a predetermined time, such as 10, 20, 24, 30, 45, or 60 seconds.

“Small Cap” means any company whose outstanding shares have a dollar value less than a particular predetermined amount, such as $1M, $500M, $1BN, $2BN, $3BN, etc. In some embodiments, Aqua minimum order size for small caps may be 5,000 shares and the shot clock may be 24 seconds.

“Mid Cap” means any company whose outstanding shares have a dollar value less than a particular predetermined amount, such as SSBN. In some embodiments, Aqua minimum order size for mid caps may be a quantity such as 5,000, 10,000, or 20,000 shares and the shot clock may be 10, 15, 18, 20, or 25 seconds. In some embodiments, the shot clock may be shorter than the shot clock for small cap.

“Large Cap” means any company whose outstanding shares have a dollar value greater than or equal to SSBN. In some embodiments, Aqua minimum order size for large caps may be 50,000 shares and the shot clock may be 12 seconds, for example.

The above definitions are exemplary definitions of some of the terms in this application, which may be used to illustrate various embodiments. One of ordinary skill in the art will appreciate that in some embodiments, these terms may have meanings that are more narrow, more broad, or otherwise different from the meanings described herein. It should also be understood that in various embodiments, these terms as used in this document may have other meanings, including meanings these terms might have in a dictionary (such as a regular dictionary or a dictionary of financial terms) and meanings that otherwise would be known or understood by those of ordinary skill in the art (e.g., without reference to these exemplary definitions).

### Detailed Description of Exemplary Embodiments

Various embodiments are directed to a trading system and method for determining orders and their prices. A trader may request a quote for a composite order comprising a plurality of constituent orders. The request may be provided to a pricing module that is located behind the trader's firewall. The pricing module may determine a quote to fill the composite order on behalf of a pricing entity associated with a fund. The quotes may be determined based on current market conditions and net tracking error that would result if the fund executed all of the constituent orders of the composite trading order. The pricing module may provide the requesting trader with the requested quote, which may comprise a firm counter-order immediately executable against the composite trading order. The trader may execute the quote, and the pricing entity may fill all the constituent trading orders of the trader's composite trading order at the quoted price(s).

The quote and the existence of the request may not be transmitted outside the trader's firewall until the trader requests to execute the quote. The pricing module may be encrypted such that information about the pricing module's pricing algorithms and information about the fund is not revealed to the trader. In this way, information about the fund and the pricing entity's pricing algorithms may be kept secret from each trader, and information about the trader's quotes and quote requests may be kept confidential from the pricing entity even though the quotes are binding on the pricing entity.

Various other embodiments are directed to a trading system and method for determining orders and their prices. A memory stores instructions which, when executed, direct the at least one processor to perform various actions, such as the following. The processor may determine a price deviation from a neutral price for one or more first orders. The first order may include an order to buy and/or sell one or more quantities of one or more securities. The price deviation may be based on a risk associated with accepting the one or more first orders. The processor may determine a plurality of second orders. Each of the plurality of second orders includes a respective order to at least one of buy and sell a respective second security. The processor may determine a reduction to the price deviation based on a combined risk associated with execution of the first order and at least one second order. The processor may accept all or a portion of the at least one first order and submit all or a portion of the at least one second order.

Various embodiments are directed to a trading system and method for determining orders and their prices. In one exemplary embodiment, a memory stores instructions which, when executed, direct the at least one processor to perform various actions, such as the following. The processor may determine a price deviation from a neutral price for a first order. The first order may include an order to at least one of buy a first security and sell the first security. The price deviation may be based on a risk associated with a respective one of owning and not owning the first security. The processor may determine a plurality of second orders. Each of the plurality of second orders includes a respective order to at least one of buy and sell a respective second security. The processor may determine a reduction to the price deviation based on a combined risk associated with execution of the first order and at least one of the plurality of second orders. The processor may transmit an indication of the first order that includes a price based on the neutral price adjusted by the price deviation and the reduction to the price deviation. The processor may receive an indication of a first execution of the first order. In response to receiving the indication of the execution of the first order, the processor may transmit respective indications of each of the second orders. The processor may receive an indication of a second execution of at least one of the second orders.

In another exemplary embodiment, a memory stores instructions which, when executed, directs at least one processor to perform various actions. The processor determines a price for a first order based on an additional risk that would be attributed to a portfolio from execution of the first order and an offsetting risk that would be attributed to the portfolio from execution of a plurality of second orders. The processor posts the first order to one or more electronic marketplaces. The processor receives an indication of a first execution of the first order. In response to receiving the indication of the first execution of the first order, the processor posts the plurality of second orders to the one or more electronic marketplaces. The processor receives an indication of a second execution of one of the plurality of second orders. In response to receiving the indication of the second execution of the one of the plurality of second orders, the processor adjusts at least one of the plurality of second orders.

In another exemplary embodiment, a memory stores instructions which, when executed, directs at least one processor to perform various actions. The processor determines a market price for buying (or selling) a first quantity of a first financial instrument. The processor determines a risk deviation to the market price based on a risk associated with buying (or selling) the first quantity of the first financial instrument. The risk deviation comprises a compensation to a buyer (or seller) of the first financial instrument for taking on a risk of owning (or no longer owning) the first quantity of the first financial instrument. The processor determines a hedged risk deviation to the market price based on a combined risk associated with (1) buying (or selling) the first quantity of the first financial instrument and (2) engaging in one or more transactions that hedge against owning (or no longer owning) the first quantity of the first financial instrument. The hedge transactions may comprise purchases and/or sales of futures and/or options on the first financial instrument. The processor determines an adjusted price for buying (or selling) the first quantity of the first financial instrument based on the market price, the risk deviation, and the hedged risk deviation. The adjusted price comprises the market price adjusted by an amount between (1) the risk deviation and (2) the hedged risk deviation. The processor transmits a first order to buy (sell) the first quantity of the first financial instrument at the adjusted price. The processor receives an indication of a first execution of the first order. The processor determines a plurality of orders to buy or sell second securities that, if accepted, would hedge against the buying (or selling) of the first quantity of the first financial instrument. After receiving the indication of the first execution of the first order, the processor may transmit one or more of the plurality of orders to one or more pluralities of users (e.g., at the same or multiple different market centers, or at an OMS as described herein).

One or more of the plurality of “hedge orders” may be executed. As each “hedge order” is executed, the processor may recalculate the amount that the risk deviation is being hedged by the executed hedge orders. In some embodiments, the processor may also recalculate the extent to which each pending “hedge order” would reduce the risk deviation (if such hedge order were executed). In some embodiments, over time, the processor may cancel pending hedge orders and/or create and submit new hedge orders that would reduce the risk deviation (if such order were executed). In some embodiments, when the risk deviation is reduced to a threshold amount (e.g., reduced by 80%, or another amount), or when the risk deviation is reduced as far as possible or practicable, the processor may cancel any remaining pending hedge orders.

In some embodiments, a method (e.g., a computer-implemented method) is provided for processing one or more orders. A price deviation from a neutral price is determined for a first order. The first order includes an order to buy or sell a first security. The price deviation is based on a risk associated with owning and not owning the first security. A plurality of second orders is determined. Each of the plurality of second orders includes an order to buy or sell a second security. A reduction to the price deviation is determined based on a combined risk associated with execution of the first order and at least one of the second orders. An indication of the first order that includes a price based on the neutral price adjusted by the price deviation and the reduction to the price deviation is transmitted. An indication of a first execution of the first order is transmitted. In response to receiving the indication of the execution of the first order, respective indications of each of the second orders are transmitted. An indication of a second execution of at least one of the second orders is received. In other embodiments, a respective second price for each of the second orders is also determined.

In some embodiments, a method (e.g., a computer-implemented method) is provided for processing one or more orders. A price for a first order may be determined based on an additional risk that would be attributed to a portfolio from execution of the first order and an offsetting risk that would be attributed to the portfolio from execution of a plurality of second orders. The first order may be posted to one or more electronic marketplaces. An indication of a first execution of the first order may be received. In response to receiving the indication of the first execution of the first order, the plurality of second orders may be posted to the one or more electronic marketplaces. An indication of a second execution of one of the plurality of second orders may be received. In response to receiving the indication of the second execution of the one of the plurality of second orders, at least one of the plurality of second orders may be adjusted.

In some embodiments, a method (e.g., a computer-implemented method) is provided for processing one or more orders. A market price for buying a first quantity of a first financial instrument may be determined. A risk deviation to the market price may be determined based on a risk associated with buying the first quantity of the first financial instrument. The risk deviation may comprise a compensation to a buyer of the first financial instrument for taking on a risk of owning the first quantity of the first financial instrument. A hedged risk deviation to the market price may be determined based on a combined risk associated with, e.g., (1) buying the first quantity of the first financial instrument and/or (2) engaging in one or more transactions that hedge against owning the first quantity of the first financial instrument. An adjusted price for buying the first quantity of the first financial instrument may be determined based on the market price, the risk deviation, and/or the hedged risk deviation. The adjusted price may comprise the market price adjusted by an amount between (1) the risk deviation and (2) the hedged risk deviation. A first order to buy the first quantity of the first financial instrument at the adjusted price may be transmitted, e.g., to another party and/or to a central system. An indication of a first execution of the first order may be received. A plurality of orders to buy or sell second securities that, if accepted, would hedge against the buying of the first quantity of the first financial instrument may be determined. After receiving the indication of the first execution of the first order, the plurality of orders may be transmitted, e.g., to a plurality of users.

In some embodiments, one or more computer systems may accomplish various features and methods described herein. For example, in some embodiments, a system may comprise a computer system associated with one or more investment portfolios and one or more trading systems. For example, a system that accomplishes various methods and functions described herein may comprise a computer system that communicates with one or more trading systems, e.g., on behalf of a large portfolio such as an index fund, mutual fund, or other financial entity. In some embodiments, the financial entity associated with the system may comprise a financial entity that holds a large portfolio, which may comprise one or more of stocks, bonds, ETFs, mutual funds, options, futures, other derivatives, real estate, other assets, and other financial instruments. For example, the entity may comprise an investment fund with a large, diversified portfolio. In some embodiments, the entity (sometimes referred to herein as “fund”) may comprise an index fund. In some embodiments, the fund may comprise a portfolio, e.g., a portfolio designed to have various features, such as particular value (or ranges of values) of alpha and beta, a particular size (or range of sizes), particular types and/or proportions of asset classes, and other design features. In some embodiments, the fund may comprise an ETF. In some embodiments, a plurality of entities may own shares or portions of the fund. In some embodiments, the fund may comprise a holding company.

In some embodiments, a system associated with the fund may submit and accept various bids, offers, hits, takes, and other transaction requests, from other market participants, e.g., on behalf of the fund. In some embodiments, a system may implement algorithmic trading on behalf of the index.

Tracking error (rho) for some index funds may be limited in some cases to about 0.01%, meaning that the index fund may remain (or be kept by making continual adjustments, e.g., daily) within 0.01% of the actual index it is tracking (such as the S&P 500). In this paragraph the term “tracking error” is used broadly and includes any measure of how much a portfolio (e.g., a portfolio of financial instruments) deviates from a measurement (e.g., a benchmark such as an index). In various embodiments, a portfolio may be designed to closely mimic or intended to closely mimic an index or another measurement. In an embodiment, a portfolio may be designed to replicate (consistently, on average or from time to time) the returns of an index exactly, close to exactly, or within a predetermined range of a target index, such as the S&P 500 (e.g., within a predetermined percentage of the return of the index). For example, the portfolio may be designed such that the return of the portfolio differs from the return of the index by no more than a return of 0.5%. In such an embodiment, the return of the portfolio could be designed to vary from as low as the return of the index minus 0.5% to as high as the return of the index plus 0.5%.

Due to various realities and errors (such as tracking error, non-market risk, non-factor, or specific risk), there may typically be a difference between amount of a particular asset (such as IBM stock) held by the fund versus how much the fund is supposed to hold to perfectly track the intended index.

In some embodiments, a trading entity such as a mutual fund or index fund may buy and/or sell large blocks of stock. The trading entity may charge premiums for the large purchases and sales to account for the tracking error the trading entity may incur as a result of engaging in the transaction. For example, if an index fund (e.g., an index fund that tracks the S&P 500) buys or sells a large block of stock, the index fund's portfolio may deviate from the index it was tracking. This deviation from its norm results in “tracking error.”

A mutual fund or index fund may price what it wants to purchase (or sell) accounting for some risk delta (portfolio, tracking error, etc). In some embodiments, it may require a premium above a “regular” price to account for the risk. The mutual fund or index fund might normally price a particular transaction (such as a “first transaction”) taking into account this risk. In some embodiments, the mutual fund or index fund may demand a premium price to account for the risk, e.g., instead of in addition to any other accounting for various risks. However, in various embodiments of the invention, the mutual fund or index fund could charge a smaller premium (such as a discounted premium, de minimis or negligible premium, or zero premium, or other amounts) based on subsequent (or simultaneous or substantially simultaneous, or predetermined) transactions that will tend to negate, hedge or otherwise address the risks associated with the premium. For example, the mutual fund or index fund can discount the premium amount by virtue of some future transaction(s) that it knows will happen (or knows are extremely likely to happen). For example, while an index fund might normally charge a large premium for selling one million shares of Exxon stock because such sale would cause significant tracking error (a deviation from its target index), it may charge a smaller premium for this transaction knowing that it could purchase an equivalent or similar quantity of BP stock and Shell stock (which may have similar risk features as the Exxon stock), and knowing that it could purchase or sell an amount of futures and/or options on Exxon stock to hedge against the sale of Exxon stock (e.g., to counteract any adverse financial performance of the fund if Exxon stock rises in value after the sale). By selling Exxon and buying other oil stocks (and/or buying and/or selling futures and/or options on Exxon), the index fund may achieve a position that has a smaller amount of total error/risk than if it had merely sold the Exxon stock (without buying other oil stocks), and so the premium demanded for the Exxon transaction need not be as high.

Thus, the index fund could charge a smaller premium for the Exxon transaction (e.g., a better price for the counterparty buyer of the Exxon stock). In some cases, the index fund may not need to charge any premium where one or more subsequent transactions (e.g., purchases or sales of hedge securities such as derivatives on Exxon stock) would serve to entirely negate the “risk/error cost” of the first transaction (selling Exxon stock). In some embodiments, the index fund may charge a premium that is somewhere between the full “risk/error cost” of the first transaction and the net “risk/error cost” of the premium needed to account for the net “risk/error cost” after the group of transactions (e.g., sale of Exxon and purchase of Shell and BP). In some embodiments, for purposes of determining the necessary premium, the index fund may estimate a future net “risk/error cost” based on current market conditions (e.g., bid and offer price and quantity data and other market data for the one or more second transactions, such as the buying of Shell and BP). Thus, in some embodiments, an index fund may engage in a first transaction (such as a sale of Exxon) that would increase its tracking error and/or incur other risk/error costs, and charge a premium for such transaction that is less than would otherwise be necessary to account for such tracking error and/or other risk/error costs.

Accordingly, for example, the index fund may hit and lift bids and offers in the market at prices that the fund otherwise would not hit or lift due to the error/risks of such transactions. For example, while a fund might normally require a 5 cent premium on sales of one million shares of Exxon stock, it may in some embodiments only require a 2 cent premium on such sales due to the fact that it can reduce/hedge at least a portion of the risk/error via one or more subsequent transactions (e.g., transactions that are currently available or are predicted to be available shortly). In such cases, the fund may elect to hit a bid on Exxon stock that is at a 3 cent premium (e.g., greater than the 2 cent premium it demands), whereas it may not have hit such bid when it required a full 5 cent premium.

In some embodiments, acceptable prices of first transactions (e.g., sale of Exxon stock that would incur tracking and/or other errors) may be determined based on market data associated with possible or available second transactions. In some embodiments, the second transactions need not be known at the time of engaging in the first transaction. In some embodiments, one or more (or all) of the second transactions are known at the time of submitting or executing the first transaction. In some embodiments, the first and one or more of the second transactions may be bundled, paired, or otherwise associated with one another, e.g., by the fund and/or by a system processing orders. In some embodiments, the first and (at least one of) the second transactions are executed simultaneously, or substantially simultaneously.

In some embodiments, an index fund may evaluate a first possible transaction by determining its tracking and other error/risk, and then determining the extent to which such error/risk can be reduced/hedged or otherwise addressed by one or more possible second transactions (e.g., based on market data for such possible second transactions). The fund may determine to engage in the first transaction based on whether the premium received for such transaction outweighs the total risk/error cost to the fund accounting for all of the first and second transactions.

For example, the system may, based on risk component(s) of trade A, look for trade B to bundle with it so that aggregate trade has less risk. For example, a large block trade in security A may be bundled with a trade for futures and/or options on A that mitigate the effect of the block trade in A.

In some embodiments, the index's algorithms for determining risk/error cost may also consider information concerning other assets in the index's portfolio, such as changes in those assets, risk/error factors (and changes) relating to those assets, and other information.

In some embodiments, the system may measure an increase in tracking error that would result from the first transaction, and price the first transaction accordingly. E.g., “two times the tracking error plus six.” The pricing algorithm may be based at least in part on variances and covariances, e.g., of one or more or all securities in the portfolio.

In some embodiments, a plurality of first transactions may be treated collectively. For example, the index fund may determine the total risk/error cost for a plurality of first possible transactions (e.g., orders from one or more counterparties), and determine one or more second possible transactions that would reduce the risk/error cost.

In some embodiments, the first transaction could be the acquisition of a party's entire portfolio.

In some embodiments, the system may engage in market making by index fund managers who bundle using tracking error; or who use risk analysis of actually available or potentially available trade bundles.

In some embodiments, various trades may be paired together, e.g., as in an order or trade similar to a spread transaction. For example, one leg of a trade (buying Exxon stock) may be paired with one or more other legs (e.g., selling Shell stock and BP stock, and/or buying or selling derivatives on Exxon stock).

In some embodiments, paired trades may be hedged. For example, one or more transactions that are long on Chevron may be paired with one or more transactions that are short on Mobil. In some embodiments, the fund may engage in these transactions because it has no market risk. In this way, the fund may end up with very small aggregate risk, and premiums on the transactions would be pure profit.

Adding and Subtracting Stocks from the S&P 500 or Dow

In some embodiments, the fund may take opportunities whenever the trade premium offsets the incremental risk. In some embodiments, the system enables index funds to own companies that recently dropped out of the target index (like S&P 500). These companies typically drop significantly in price when they are removed from the S&P 500, largely because index funds (e.g., that track the S&P 500) must rebalance their portfolios to mirror the current make-up of the S&P 500. Accordingly, when the S&P 500 changes, they must change also by selling the stocks departing from the S&P 500 and buying the stocks of the companies being added to the S&P 500. The selling pressure on the “subtracted” stocks depresses their market price, and the buying pressure on the “added” stocks inflates their prices.

To avoid buying at inflated prices and selling at depressed prices, index funds sometimes start buying the “added” stocks and selling the “subtracted” stocks before they are actually added or subtracted from the S&P 500. The more favorable prices can partially or wholly offset (or more than wholly offset) the adverse consequences of the additional tracking error due to the increased deviation from the official current makeup of the real S&P 500. After a transition period when most index funds have sufficiently bought in to the added stocks and sold off the subtracted stocks, the buying and selling pressure will be reduced and the prices may effectively return to their “normal” levels. Notably, the increased and decreased market prices are due largely the result of the listing or delisting from the S&P 500, and not from any change in the company's p/e or other business fundamentals. In this sense, the price changes could be considered somewhat “artificial.”

A fund associated with the system may also tracking the S&P 500, and thus may need to buy the same “added” stocks and sell the same “subtracted” stocks. Accordingly, like other index funds, the fund may buy early into the “added” stocks and sell early the “subtracted” stocks. In some embodiments, the system may want to keep stocks predicted to be added to the S&P 500 and sell ones that will be deleted. Regardless of how effective the system is in accomplishing this goal, it may at least be factored into the system's pricing and hedging decisions. For example, the system may be willing to pay a marginally higher price for a stock that is likely to become an S&P 500 stock, and may be willing to sell at a marginally lower price a stock that is expected to be removed from the S&P 500. In some embodiments, the system may calculate a permissible price deviation based at least in part on a determined likelihood that the stock will be added or subtracted from the S&P 500 and the amount of time until such adding and subtracting (wherein a higher time increases tracking error for transactions intended to track a future but not current version of the target index). The system may have a goal to build up a surplus of stocks likely to be added to the S&P 500 so that it is ready to track the “new” S&P 500 list of stocks once they update their list, and to build up a deficit in stocks that are likely to be removed from the S&P 500 (for a similar reason). Naturally, this would increase the system's tracking error while it builds up the surplus and deficit.

The system may also participate in transactions relating to these added and subtracted stocks in the manner described herein. For example, even though the system may itself be tracking the S&P 500, it may deviate from “normal” index fund behavior by selling the stocks being “added” and buying the stocks being “subtracted.” For example, it may buy and sell from competing index funds that are trying to best mimic the S&P 500. While engaging in these transactions would tend to increase the fund's overall tracking error, the tracking error could be offset (or more than offset) by the price premiums charged in the transactions (e.g., the higher prices charged when selling an “added” stock and the lower prices of buying a “substracted” stock). Additionally, futures and options on the added and subtracted stocks could further reduce the errors/risk to the fund. Instead of buying at inflated prices and selling at depressed prices, the fund can instead buy at depressed prices and sell at inflated prices. The system could use pricing algorithms described herein to ensure that the “profit” from buying low and selling high more than offset the increased tracking error, also considering all the hedging transactions (e.g., buying and selling “equivalent” stocks, futures, and options to best mimic the model fund).

In some embodiments, the system can help other tracking funds make the switch as painlessly as possible by letting them sell to and buy from the system's inventory/fund, and using secondary transactions to hedge or otherwise minimize the negative impact of those transactions. Thus, if IBM is added to the S&P 500, the system could sell its inventory of IBM to all the tracking funds at a price premium and hedge those sale transactions. The system would eventually need IBM stock to reduce its tracking error, but it could do this later when there is less of a buying and selling frenzy.

In some embodiments, the index fund may engage in large block trading.

In mutual fund trading parlance, the term “alpha” may indicate or represent a measure of how far a rate of return or other metric (e.g., for an stock investment or portfolio) may diverge from a reference such as an index. (In some embodiments, alpha may correspond to a long term rate of return.) In some embodiments, the system may tend to maximize Alpha without affecting “Beta”, which may represent or indicate a measurement such as a metric related to risk and/or variance, or how much a related curve varies over time (e.g., how “jaggy” is the curve.) A beta of 1 may mean the portfolio is exactly as risky as the average security in the portfolio. A lower may indicate that the portfolio has less risk than the average security in the portfolio.

Bundled transactions may be attractive to buyers on the market. In some embodiments, a system according to some embodiments may offer bundled transactions or accept offers for bundled transactions.

In some embodiments, a system associated with an index may seek out one or more potential trades that would decrease its portfolio risk. The index may engage in trades for which premium it receives is greater than the risk it incurs.

In some embodiments, a fund may comprise a type of “S&P 499” fund that is not quite an index fund (like the S&P 500, a “real” index fund) because it enables more deviation from an intended fund, provided that the tracking and other errors are outweighed by transaction premiums.

In some embodiments, a fund (e.g., operating in conjunction with various embodiments of the systems described herein) may accept orders and other trade requests from other entities. In some embodiments, the fund may accept trades with other entities regardless of the identity of such entities. In other embodiments, the system may trade preferentially with some entities or entity types (e.g., individual traders trading small volumes of a specific stock) over other entities or entity types (e.g., mutual funds or other large institutional traders trading algorithmically, or trading large blocks of stock).

In some embodiments, the fund may price a trade with another entity based on the impact such trade will have when compared to the fund's target static portfolio, which may have several target characteristics such as a target portfolio make-up (e.g., defined by specific assets or asset types and their proportions, e.g., 50% Google stock and 50% IBM stock by volume, or 40% large cap American companies and 60% mix of real estate and small cap foreign companies, or 30% GE common stock, 30% oil industry investments, and 40% investment in an S&P 500 index fund, for example). In some embodiments, the fund may engage in trades that cause it to deviate from its “target” make-up. (For example, over a trading day the fund may end up with 51% Google stock and 49% IBM stock by volume instead of a targeted 50-50 ratio.)

In some embodiments, the fund may engage in transactions (or favor transactions by favorably pricing or accepting orders), that tend to move the fund closer to its target make-up. For example, if the fund is heavy in Google stock, the fund may tend to favor transactions that cause it to lower its share in Google stock. For example, the fund may lower the price at which it is willing to sell Google stock, e.g., and submit sell orders and/or accept other traders' buy orders for Google stock at a lower price than it typically would be willing to sell. The difference in price may be priced according to the change in tracking error (e.g., and/or other errors) associated with the transaction.

Accordingly, trades that, if accepted, would tend to fill “holes” in the fund's current portfolio to move towards the target may be desirable to the fund (and priced accordingly), and trades that (if accepted) would tend to make “holes” (e.g., by moving the fund away from its target) may be undesirable to the fund. The amount of the impact may be used to set the price of the fund's orders and acceptances.

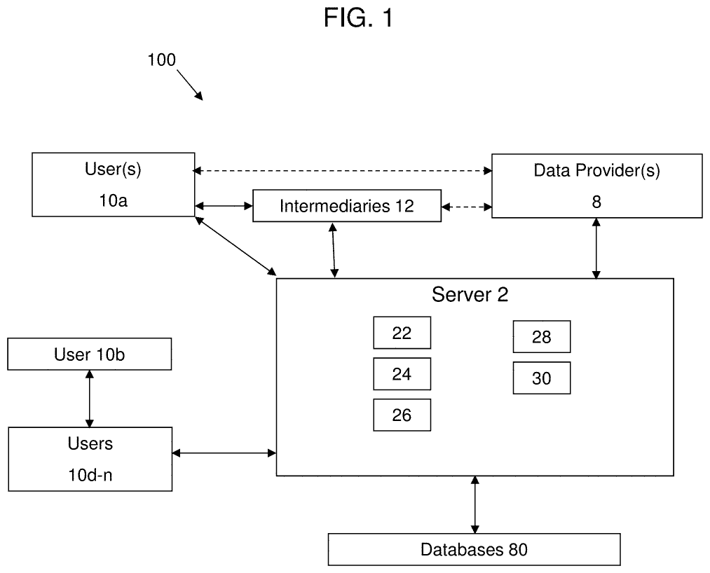

FIG. 1. Exemplary System

Some embodiments of the present invention provide systems and methods for pricing orders and/or managing a portfolio. FIG. 1 depicts a system according to at least one embodiment of the systems disclosed herein.

The system 100 may comprise one or more servers 2 coupled to one or more databases 80, one or more data providers 8a-8n, one or more end users 10a-10n, and one or more agents 12. The data providers 8a-8n, users 10, agents 12, and server 2 may each communicate with each other. Users 10 may also communicate with other users 10.

System 100 and server 2 may perform the functions described herein for a fund, CCA, Aqua ATS, and Quantal.

Server 2 may comprise one or more processors, computers, computer systems, computer networks, and or computer databases. Server 2 may comprise modules 18-64. Server 2 may also comprise one or more databases, such as databases 80. Server 2 may communicate with users 10, data providers 8, and agents 12. For instance, server 2 may communicate with a user 10 computer, such as a browser of a user computer, e.g., over the internet.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Users 10a-10n may comprise one or more human persons, computers, terminals, users, traders, trading entities, or other entities. Users 10 may interact with agents 12, server 2, and/or other users 10. As used in this application, users 10a-10n may also refer to a user's interface to other system 100 components (like server 2), such as a user's PDA or computer or a program running on a user's computer such as a computer web browser like Internet Explorer™, which may communicate with data providers 8, agents 12, and/or server 2.

Data provider(s) 8 may comprise any person, processor, information service, or other entity that publishes or otherwise provides information relating to one or more financial instruments, markets, trading platforms, traders, orders, or other financial- or trade-related information. In some embodiments, the data may include information that may be of interest to or used by a user 10 or server 2.

Data provider 8 may provide information in real time, as information is created or as it first becomes available to the general public, or at another time. Data provider 8 may provide such information in any one or more of a variety of forms and means such as video, audio (e.g., radio broadcast), text (e.g., stock ticker-type information), or other data that may convey information. Data may be provided at a variety of different timings. In some embodiments, data may be provided in periodically, continuously, or continually, e.g., via a data feed (e.g., a stream of data that includes real time updates of trading-related information). In some embodiments, data may be provided after an event, e.g., a trade or submission of an order.

In some embodiments, data provider 8 may provide to server 2 (and/or agents 12 and/or users 10) trading-related information.

Intermediaries 12 may comprise one or more trading-related entities such as a broker, fund manager, or other entity that interacts with users, data providers, and server, but is separate from those entities.

The server 2 may comprise a computer, server, hub, central processor, or other entity in a network, or other processor. The server 2 may comprise input and output devices for communicating with other various system 100 elements. In some embodiments, the server 2 may comprise a trading platform, an exchange, a fund or fund management system, an order matching system, or other processing system.

In some embodiments, the server 2 may be comprised in an end user's computer 10, e.g., as a toolbar in a user's web browser or another program running on the user's computer.

As shown in FIG. 1, the server 2 may comprise a plurality of modules, such as modules 22-34. Each module may comprise a processor as well as input and output devices for communicating with other modules, databases, and other system elements.

User interface module 22 may communicate with users.

User interface module 22 may cause information to be output to a user, e.g., at a user output device such as a display device (e.g., a display device at a user terminal), a speaker. The information outputted to a user may be related to a user account, preferences, and other information described herein. User interface module may communicate the information electronically, e.g., via networked communication such as the internet (e.g., in an email or webpage), telecommunication service, etc. In some embodiments, user interface module 22 may comprise input devices for users to communicate trading-related information.

User preferences module 24 may receive, identify, or determine user preferences concerning one or more portfolios. For instance, the module may receive the preferences from a user interacting with a user interface. The module may also receive them from an automated user terminal. The module may also determine them based on a program that automatically determines user preferences concerning one or more portfolios or securities.

Financial information module 26 may determine financial information associated with one or more orders, trades, financial instruments, portfolios, funds, financial metrics, and other financial information.

Search module 28 may search for and/or identify and/or solicit one or more securities, orders, and/or counter-parties, e.g., concerning one or more orders. For instance, search module may search one or more financial databases (e.g., a database that stores orders or counter-party preference information), e.g., via the internet, to determine one or more securities or orders that satisfy one or more parameters, such as parameters based on preferences from a user.

Price module 30 may determine and associate one or more values or prices with one or more orders, securities, portfolios, or other financial entities, e.g., as described herein. For instance, price module 30 may determine a price, e.g., for an order, or to be paid to or received by a user or server, e.g., for one or more securities. For instance, price module may determine a price or value (such as a net present value) that an entity such as a fund is willing to pay for or sell a particular portfolio (e.g., a quantity of a security offered for purchase or sale, e.g., in a trading order). Prices may include a current price, a historical price (e.g., a price such as a market price at a prior time, such as a week earlier), and an estimated future price (e.g., based on changing price information, such as a recent increase or decrease in a price over a recent period of time).

Databases

As shown in FIG. 1, a database 80 may be coupled to the server 2. The database 80 may comprise a plurality of databases as described below. Databases 80 may store information about users, elements, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

An Exemplary Method

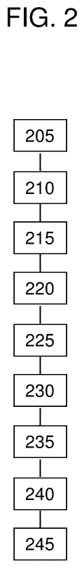

FIG. 2 depicts a flow diagram according to at least one embodiment of the methods disclosed herein.

It should be understood that each function(s) described for each block may be performed using a module capable of performing that function, e.g., according to methods described for each module above. It should also be appreciated that the acts described in these blocks may be performed in any order (including but not limited to the exemplary orderings shown on the diagram), and not all blocks need be performed.

In block 205, the system 100 (e.g., one or more processors of server 2) may receive a first order, e.g., as described herein. The first order may include an order to at least one of buy a first security and sell the first security.

In block 210, a processor may determine a price deviation from a neutral price for a first order, e.g., as described herein. The price deviation may be based on a risk associated with a respective one of owning and not owning the first security.

In block 220, the system may receive a plurality of second orders, e.g., from one or more users, e.g., as described herein. Each of the plurality of second orders may include a respective order to at least one of buy and sell a respective second security.

In block 225, the processor may determine a reduction to the price deviation based on a combined risk associated with execution of the first order and at least one of the plurality of second orders, e.g., as described herein.

In block 230, the processor may transmit an indication of the first order that includes a price based on the neutral price adjusted by the price deviation and the reduction to the price deviation, e.g., as described herein.

In block 235, the processor may receive an indication of a first execution of the first order, e.g., as described herein.

In block 240, in response to receiving the indication of the execution of the first order, the processor may transmit respective indications of each of the second orders, e.g., as described herein.

In block 245, the processor may receive an indication of a second execution of at least one of the second orders, e.g., as described herein.

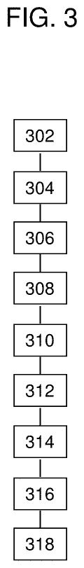

FIG. 3 depicts a flow diagram according to at least one embodiment of the methods disclosed herein.

In block 302, the processor determines a market price for buying a first quantity of a first financial instrument, e.g., as described herein. (In some embodiments, the first quantity of the first financial instrument may be interpreted as a plurality of quantities of a plurality of different financial instruments. In still other embodiments, the “buying a first quantity of a first financial instrument” may comprise “buying and/or selling a plurality of quantities of a plurality of financial instruments.”)

In block 304, the processor determines a risk deviation to the market price based on a risk associated with buying the first quantity of the first financial instrument, e.g., as described herein. As described herein, the risk deviation may comprise a compensation to a buyer of the first financial instrument for taking on a risk of owning the first quantity of the first financial instrument. The risk deviation may also price in other risks and costs associated with owning the first quantity of the first financial instrument.

In block 306, the processor may determine one or more transactions that hedge against owning the first quantity of the financial instrument, or otherwise reduce the net risk/costs (e.g., including tracking error) associated with owning the first quantity of the financial instrument. For example, if owning the first quantity comprises owning 1000 shares of Apple stock, the one or more hedging transactions may comprise taking short positions in Google and IBM (e.g., selling Google stock and selling IBM stock).

In block 308, the processor may determine a hedged risk deviation to the market price based on a combined risk associated with (1) buying the first quantity of the first financial instrument and (2) engaging in the one or more transactions that hedge against owning the first quantity of the first financial instrument, e.g., as described herein.

In block 310, the processor may determine an adjusted price for buying the first quantity of the first financial instrument based on the market price, the risk deviation, and the hedged risk deviation. The adjusted price comprises the market price adjusted by an amount between (1) the risk deviation and (2) the hedged risk deviation, e.g., as described herein.

In block 312, the processor may transmit a first order to buy the first quantity of the first financial instrument at the adjusted price, e.g., as described herein.

In block 314, the processor may receive an indication of a first execution of the first order, e.g., as described herein.

In block 316, the processor may determine one or more orders to buy or sell one or more second securities that, if accepted, would hedge against the buying of the first quantity of the first financial instrument, e.g., as described herein.

In block 318, after receiving the indication of the first execution of the first order, the processor may transmit the plurality of orders to a plurality of users, e.g., as described herein.

It should be appreciated that the actions described in the blocks for the methods described herein are exemplary only, and need not be performed in the order presented here. Further, it is not necessary to accomplish all of the actions described in the blocks. Rather, any number of the blocks (e.g., four of the blocks or six of the blocks) may be accomplished, and in any order. Further, the actions described herein may be combined with any other actions described herein, in any order.

Business Model

In some embodiments, Cantor Fitzgerald may offer an investment service to buy-and-hold equity fund managers that may provide them with the opportunity to allocate portions of their inventory to managed funds operated by a the system (e.g., Cantor Comparative Advantage, or CCA). In some embodiments, the system (e.g., CCA) may generate revenue by actively trading the equity inventory contributed by customers and may share profits with customers.

In some embodiments, the system (e.g., CCA) may in some embodiments only offer this service to S&P 500 index fund managers because, all else equal, it may be slightly safer to restrict the universe of a portfolio's stocks to the constituents of the benchmark, which is typically the policy of enhanced index managers. However, the model that CCA's partner, Quantal, has developed applies globally to traded stocks which pass a minimal liquidity constraint, currently about 7,300 in the U.S. Index funds typically produce returns close to the returns of the benchmark they are tracking, but passive management fees, positive cash balances, security imbalances and lending revenues cause them to produce returns that differ from those of the benchmark. An investment strategy that enhances the index fund return for its investors should be popular, especially when there are no baseline management fees.

In some embodiments, Quantal may produce ladders of discount bids and premium offers (so-called reservation prices) for S&P 500 stocks. Essentially, the inventory-cost component of the model produces either a premium that would be needed as compensation for a trade that pushes the fund out of balance with respect to its benchmark, or a zero-cost offer to do a trade that moves the portfolio back toward the index. The model may be driven by:
risk factors (the so-called betas and deltas, or B's and D's) generated by Quantal's existing portfolio risk analysis tools that are used to create a covariance matrix that contains correlations between all (or some portion of) S&P 500 member stocks,
the customers willingness to take risks (the greater the risk tolerance, the lower the discounts or premiums),
current stock positions, and
current stock quotes in the open market.

Reservation prices may be offered to Aqua's buyside clients for large blocks of S&P 500 stock—the larger the block, the larger the discount or premium. CCA's revenue model relies on the willingness of the Aqua buyside and/or external market to pay these premiums to reduce exposure risk. From Aqua's perspective, this model may help add liquidity to the Aqua ATS, not just in the top 70% of U.S. companies by market capitalization that are represented in the S&P 500 index, but potentially also those companies outside of the S&P 500 that have strong correlations with companies in the index. In general CCA and/or Aqua may expect there to be additional risk in trading stocks outside the S&P 500 index for a fund benchmarked to the S&P 500.

In addition to, and independently of, the reservation price algorithm, a noise trading algorithm may run that constantly tries to realize profits by trading in the open market in small orders of a few thousand shares by setting prices a few cents away from the market for very short periods of time. Noise trading can generate profits continuously until stock prices either go into steady gain or steady decline at which point a small short or long position can accrue (again, in the thousands of shares). Noise orders are designed to rest in an external limit order book for a short period of time until they trade, so they may be eligible for rebates that may be contributed to the fund.

Additional trading algorithms like market-on-close orders and midsized orders are contemplated but may not be available in various embodiments.

Residual cash in any system (e.g., CCA) fund may be equitized by purchasing S&P 500 futures contracts whose mark-to-market value is equal to cash held; as cash decreases, futures positions may be reduced commensurately.

Customers and Investors

In some embodiments, the system (e.g., CCA) may invite equity fund managers to allocate a portion of their inventory in the form of stocks and cash to the system (e.g., CCA) trading model. These customers may in turn offer participation in the system (e.g., CCA) to their investors. Customers and investors are incentivized to participate in CCA by being given a significant portion of the revenue generated by the model (as described herein) while assuming the risk of the fund making a loss.

In some embodiments, a customer may allocate all (or substantially all, or some portion of) stocks and cash provided by individual investors into a single fund for investment in the index fund that the system (e.g., CCA) manages on these customers' behalf. In some embodiments, the system (e.g., CCA) may not keep track of individual investors' allocations—in some embodiments, this may be the responsibility of the customers. Customers may increase or decrease their investment in their fund at any time between trading days, provided they maintain some agreed upon minimum investment in the fund (as described herein).

In some embodiments, each index fund may operate independently of (some or) all other funds, meaning that one customer's reservation spread orders may compete with another's in the Aqua ATS and their noise orders may compete in the equity markets.

Minimum Investment, Revenue and Revenue Sharing

A Quantal study has shown that at least in some cases, when only inventory risk is considered and with an index fund valued at $50BN, an investor with average risk tolerance should be willing to buy or sell 100,000 shares of a large-cap medium priced stock at about a one penny premium to offset the risk of trading out of that position. In some embodiments, with this size of investment from a customer, the system (e.g., CCA) may be able to offer competitive pricing to Aqua buyside clients; at lower investments, the maximum number of shares that can be offered at a one penny premium goes down, making the system (e.g., CCA) prices less attractive to Aqua clients.

The following table gives a sense of how many shares of the top five S&P 500 members by weight that the system (e.g., CCA) could hold in a perfectly weighted $50BN fund, as of Aug. 13, 2008:

| | | | Dollar Value | Closing | Number of |
|---|---|---|---|---|---|
| | | % | Held In Fund | Price | Shares Held |
| Company | Symbol | Weight | ($MN) | ($) | in Fund |
| ExxonMobil | XOM | 3.68 | 1,840 | 78.17 | 23,538,441 |
| General | GE | 2.60 | 1,300 | 29.31 | 44,353,462 |
| Electric | | | | | |
| Microsoft | MSFT | 1.99 | 995 | 27.91 | 35,650,304 |
| Procter & | PG | 1.89 | 945 | 69.60 | 13,577,586 |
| Gamble | | | | | |
| Johnson & | JNJ | 1.79 | 895 | 71.20 | 12,570,224 |
| Johnson | | | | | |

Similarly, the next table lists how many shares of the bottom five S&P 500 members by weight that the system (e.g., CCA) could hold in a $50BN fund, as of Aug. 13, 2008:

| | | | Dollar Value | Closing | Number of |
|---|---|---|---|---|---|
| | | % | Held In Fund | Price | Shares Held |
| Company | Symbol | Weight | ($MN) | ($) | in Fund |
| Titanium | TIE | 0.01 | 5 | 11.66 | 428,816 |
| Metals | | | | | |
| Meredith | MDP | 0.01 | 5 | 29.18 | 171,350 |
| MGIC | MTG | 0.01 | 5 | 7.11 | 703,234 |
| Investment | | | | | |
| Dillard's | DDS | 0.01 | 5 | 11.20 | 446,428 |

Thus, in some embodiments, even at the lowest weights in a $50BN fund, CCA would still be able to demand at least a one penny premium from Aqua clients.

In some embodiments, the revenue generated as a result of trading fund inventory is broadly defined as the positive difference, if any, between the performance of the fund and the performance of the benchmark over a period of at least one business day. CCA may record fund and benchmark performance daily, or at other frequencies, such as hourly, monthly, or after a predetermined event, such as an occurrence of a transaction exceeding a predetermined threshold.

In some embodiments, revenue may be shared between a number of parties such as the customer, the investors, Quantal, and the system (e.g., CCA). Revenue may be reported to a customer as a single profit (loss) for each fund that the system (e.g., CCA) may manage for them; in some embodiments, the customer or another party may be responsible for dividing these earnings among participating investors.

Investment Delivery

In some embodiments, the customers may provide the system (e.g., CCA) with existing balanced index funds and cash (expected to be about 5% of the total value) with which to buy and sell futures positions to handle deviations from optimal market value caused by trading. In some embodiments, To the extent that the customers provide assets in some other form, the system (e.g., CCA) may arrange, at the customers' expense, to convert the portfolios to the form CCA would like or enter into a bargain with the customers reflecting the degree to which the imbalances should impact tracking error for the index fund in the future.

Reservation Price Model

In some embodiments, one or more trading algorithms used by the system (e.g., CCA) product (as described herein) may use Quantal's reservation price model to generate reservation bid and ask prices at which the system (e.g., CCA) would be indifferent as to buying or selling stocks in the fund at a point in time, given the fund's holdings at that time. In some embodiments, If the system (e.g., CCA) can do better than those reservation prices under existing market conditions, it stands to earn “economic rents” (profits). In some embodiments, the system (e.g., CCA) may determine a set of rules for quoting prices given reservation prices; these rules segment orders/trades into three types that capture market conditions:
large (“reservation price”) orders;
midsized orders; and
small (“noise”) orders.

In some embodiments, Quantal's reservation price model produces bid and ask prices relative to a currently existing “market price”—that is, spreads relative to the existing market price at which CCA would at the margin be willing to buy or sell stocks. In some embodiments, The market price may be proxied by the mid-point of the most recent inside bid and ask quotes in the market (the NBBO), and the bid or ask price may be quoted by the model as a spread to that midpoint. In some embodiments, Qua a spread model, Quantal generates ladders of spreads for a range of order sizes, or reciprocally, ladders of order sizes for an array of spread increments. In some embodiments, the spreads are the minimum amount which the system (e.g., CCA) would prefer to execute a given size order.

In some embodiments, the minimum spread, or reservation spread, may be positive for trades that move a fund away from balance with respect to its benchmark index, and negative for trades that reduce a fund's imbalance. In some embodiments, CCA may not generally wish to do all trades at the reservation (i.e. “bare minimum”) prices, but rather may want to do the trades at prices “which the market will bear.” For example, tracking-risk-reducing orders may be quoted at a zero spread to midpoint, similar to an NYSE Midpoint Liquidity Order, not at a negative spread, save possibly in a stress environment where CCA might logically be willing to pay to reduce risk.

The reservation spreads are determined in the Quantal model as compensation for three elements of risk in trading away from the index, or back toward the index:
1. Inventory risk, whereby trades that move a fund away from a benchmark index expose the fund to a higher tracking error, i.e. a higher probability that the fund's return will deviate from that of the customer's benchmark.
2. Adverse selection risk, i.e., risk that the fund incurs losses when it posts quotes that can be “picked off” by better-informed traders in the crowd—the fund will on average be on the wrong side of these trades—by definition, prices will on average rise after the fund has sold stocks to these better-informed traders, and fall after it has purchased stocks from them.
3. Manipulative trading risk, that is, risk that arises if traders can successfully manipulate prices (and avoid legal consequences). Manipulative traders in this category are defined to have no “inside” information about the company. Rather, the manipulative trader forces the midpoint of the bid and ask quotes to be transitorily away from the market's “equilibrium price” by his trading actions.

One form of manipulative trading is predatory trading; a predatory trader sells alongside a distressed trader who feels the need to liquidate his positions—thereby causing prices to overshoot on the downside—and then begins buying back at those low prices. Predatory trading can accentuate so-called “contagion” in price movements—note that ultimately it is an institutional constraint or rigidity that makes predatory trading strategies profitable.

A second example of manipulative trading could be front-running whereby the trader rapidly takes out all the quotes on the bid side of the market and thereby pushes at least the inside bid quote down to a very low tier on the posted bid ladder. If these low prices have pushed out other potential buyers at these prices, the manipulative trader could then submit large buy orders with little competition at these temporary disequilibrium prices. If all market players remain in the market and there are no rigidities or delays in revising quotes, then the manipulative trader strategy would on average be unsuccessful—when he submits the large order, he would simply push quotes, and the price that he pays, back up along the same linear schedule on which he pushed quotes down; of course, even if manipulative traders break even on average (and CCA may break even against them), they could add significant volatility to its strategy.

Safeguards may be used to prevent or curb possible manipulation. First, manipulation of the bid and/or ask quotes could be prohibitively expensive for a liquid high-volume stock, and in some embodiments the system (e.g., CCA) may focus only on S&P 500 constituents. Second, if the bid and ask quotes used to calculate the mid-point are those immediately preceding the trade, then a safeguard would be a rule that limits the change in the midpoint from the bid-ask midpoint at the time (say) that the counter-order is submitted. Brokers do this now.

In some embodiments, only the inventory costs of trades may be considered in the Quantal model when it generates the reservation spread ladder. (In other embodiments, other costs and factors may be considered.) Different size trades may expose the fund to different size potential risks, and thus different preferred compensation—positive or negative—for those trades; as a result, the Quantal model may produce a ladder of reservation spreads and concomitant trade sizes. In some embodiments, positive spreads may be preferred for trades on the ladder that, if consummated, would move the fund further out of balance with its benchmark. In some embodiments, If a stock is out-of-balance and a trade would move the fund back toward its benchmark, then at the margin CCA would be willing to pay to do the trade. For these trades, the rule that CCA may adopt is to do the trades at a zero spread—that is, at the midpoint—and earn an economic rent equal to zero less the negative reservation spread. This provides the best opportunity to minimize tracking error while locking in profits. In some embodiments, As an incentive, Aqua may also offer a rebate of half a penny per share for any midpoint order executed in the Aqua ATS.

The frequency with which the reservation spread ladder is recalculated, and the rules (“algorithm”) for updating price quotations relative to the reservation spread ladder, both at and between recalculation times, may be predefined. These rules for price-setting relative to the reservation spreads differ among large, midsized and small orders and are discussed in detail below.

Large Trades

In some embodiments, the cutoff size defining a large trade may be determined by Quantal research. In some embodiments, the cutoff may take into account the size of the underlying fund and the stock's contribution to the overall tracking error (thus all else equal a stock with more “factor risk” will, for a given number of shares, be a larger trade) and the average daily volume of trading in the stock. Of course, trivially a large trade would be any size above a midsized trade, the next-smallest trade size category, and in that respect it might seem that the system (e.g., CCA) is just arbitrarily defining a boundary between them. However, the midsized order may also differ from a large order with respect to the spacing of quotes on the ladder and the place where it trades—the midsized order may be posted in an external limit order book, whereas large orders may not be posted externally until the adverse selection and possible price manipulation are dealt with in the model.

The reservation spread ladder across all (or a portion of) stocks may be immediately recalculated after a large or midsized trade in any stock, as differentiated from noise trades that may be updated, e.g., at 15 or 30 second intervals, e.g., unless their cumulative total before update breaches a pre-specified limit on either side.

In updating the quote ladder for large or mid-size orders, the system (e.g., CCA) may want to minimize the discontinuity in posted quotes. There is a potential loss of business if potential contra-parties/algorithms come to brand the system (e.g., CCA) quotes with a “now you see them, now you don't” moniker and thus hardly may be worth the bother, in some embodiments. In some embodiments, the problem of discontinuity in the spreads may be smaller than first thought: the spreads are generated in one cent steps by the code. As an example, the system (e.g., CCA) might see the following spreads for 10,000 share order increments:

| Bid Size | Existing Spread |
|---|---|
| 0 | 0.00 |
| 10,000 | −0.01 |
| 20,000 | −0.01 |
| 30,000 | −0.01 |
| 40,000 | −0.01 |
| 50,000 | −0.01 |
| 60,000 | −0.02 |
| 70,000 | −0.02 |

| Bid Size Range | Existing Spread |
|---|---|
| 0 | 0.00 |
| 50,000 | −0.01 |
| 100,000 | −0.02 |
| 150,000 | −0.03 |
| 200,00 | −0.04 |

| Ask Size | Existing Spread |
|---|---|
| 0 | 0.00 |
| 10,000 | 0.01 |
| 20,000 | 0.01 |
| 30,000 | 0.01 |
| 40,000 | 0.01 |
| 50,000 | 0.01 |
| 60,000 | 0.02 |
| 70,000 | 0.02 |

| Ask Size Range | Existing Spread |
|---|---|
| 0 | 0.00 |
| 50,000 | 0.01 |
| 100,000 | 0.02 |
| 150,000 | 0.03 |
| 200,000 | 0.04 |

Now, let's suppose that the system (e.g., CCA) buys 10,000 shares. A revised schedule might be as follows:

| Bid Size | Revised Spread |
|---|---|
| 0 | 0.00 |
| 10,000 | −0.01 |
| 20,000 | −0.01 |
| 30,000 | −0.01 |
| 40,000 | −0.01 |
| 50,000 | −0.02 |
| 60,000 | −0.02 |
| 70,000 | −0.02 |

| Bid Size Range | Revised Spread |
|---|---|
| 0 | 0.00 |
| 40,000 | −0.01 |
| 90,000 | −0.02 |
| 140,000 | −0.03 |
| 190,000 | −0.04 |

| Ask Size | Revised Spread |
|---|---|
| 10,000 | 0.00 |
| 20,000 | 0.01 |
| 30,000 | 0.01 |
| 40,000 | 0.01 |
| 50,000 | 0.01 |
| 60,000 | 0.01 |
| 70,000 | 0.02 |
| 80,000 | 0.02 |

| Ask Size Range | Revised Spread |
|---|---|
| 10,000 | 0.00 |
| 60,000 | 0.01 |
| 110,000 | 0.02 |
| 160,000 | 0.03 |
| 210,000 | 0.04 |

Notice that in some embodiments, the only “disruption” occurs here in the bid quote spread for the 50,000 share order (of course, it is possible to imagine a huge trade where the spreads change at all sizes, but in that case, the disruption would be advisable). The decision is to whether the “disruption effect” for the 50,000 share order is sufficiently large to warrant incurring the cost in deviating from the reservation quote.

In some embodiments, the reservation price model may be implemented such that the terminating rung in a ladder represents the maximum number of shares the system (e.g., CCA) may be willing to buy or sell in the stock at the time the ladder is generated and is dependent upon the amount of cash or shares held (see below for further details). For practical purposes, the system (e.g., CCA) may like to keep the number of ladder rungs down to a fixed and small number, initially 20 (see below) and therefore the ladder spread increment may vary as a function of the spread at the terminating rung of the ladder; for example, if the terminating rung has a spread of 50 cents, then the spread increment may be 2.5 cents per rung, assuming that the model (in some embodiments) only considers inventory cost.

In some embodiments, large trades may occur (e.g., only) in interaction with block desks and via matches within the ATS system. In some embodiments, to the extent that adverse selection problems may be smaller in the block desk/ATS context, the system (e.g., CCA) may take the position a priori that the reservation spread ladder reflecting the inventory cost component of the model may be relatively important for these large trades.

Format of Ladder Output; Granularity in Quoted Spreads

The tiers in the ladder are currently quoted in terms of marginal spreads at different tiers, i.e. $10.80 for size 10,000 ask, $10.83 for 20,000 ask, is output as a marginal 3 cents for a marginal 10,000 shares. The system (e.g., CCA) may need to take care that this is not confused with the normal way in which order books are displayed.

In some embodiments, the reservation spread model may use a different granularity for very high-priced stocks, e.g., Berkshire-Hathaway or Google. It is quite straightforward to feed the model a vector for quote increments for each of the 500 stocks. In some embodiments, Quantal may provide a rule for determining the desired grid, which should be align with observed spreads.

Index Reconstitutions

In some embodiments, from time to time, stocks may be replaced in the S&P Index by the S&P Committee, for example where a company is de-listed because it is taken private or merged, or because it has become “less representative” of the U.S. stock market in the judgment of the Committee (in the case of other indexes, e.g. the Russell indexes, stocks enter and leave the index based solely on their relative market cap).

For a relatively strict indexer, rules for replacing stocks in the Index are virtually the one place for “action,” e.g. an indexer may believe it can make a near-arbitrage gain by beating the herd to trade before or, if applicable, after, the Index reconstitution. Given that the system's (e.g., CCA) sub-advisor mandate may not include playing the reconstitution “game,” the system (e.g., CCA) may not build that into the strategy in some embodiments.

Since, in some embodiments, the system's (e.g., CCA) strategy may not include the index reconstitution game, the system (e.g., CCA) may anticipate adhering to the following plan of action: when stocks are deleted from the index, the system (e.g., CCA) may pass the physical shares of that stock held by the fund back to the customer, and vice versa for the shares added to the index. The transfers take place at the closing price used in calculating the index, and thus add no tracking error to the index. In some embodiments, If the customer has an index reconstitution strategy for their underlying mandate, they may be able to take/provide the physical shares and still execute their strategy. The transfer-in-the-event-of-index-reconstitution mechanism has the advantage that it is consistent with the initial receipt of shares by the fund, which should be in strict proportion from the index and thus free from tracking error on day one.

One alternative strategy is that the system (e.g., CCA) may have the customer pay CCA an agreed upon price for trading in and out of the arriving and departing names.

Trading Algorithms

In some embodiments, The CCA product may employ several algorithms that use Quantal's reservation price model (see section 4 above) to opportunistically trade CCA holdings in various U.S. equity trading venues. Each algorithm may run independently of one or more or all other algorithms, and each fund's algorithms may run independently of those for one or more or all other funds. In some embodiments, any algorithm may be turned on or off manually; in some cases, algorithms may employ circuit breakers to turn themselves off automatically.

5.1 Reservation Price (Large Order) Trading

CCA reservation price trading looks for opportunities to trade large blocks of stock with Aqua ATS clients at discount bids and premium offers, and on the external market once the adverse selection and market manipulation component are added to the reservation price model. Ladders of discount and premium spreads and sizes at which CCA is willing to trade them are generated by Quantal's reservation price model and electronically delivered to the Aqua ATS which may then present CCA firm orders at a price equal to the mid-point plus the discount or premium to Aqua clients who are eligible to view those orders.

In some embodiments, discounted bid and premium offer prices may (e.g., only) be demanded for trades in a stock that would increase tracking error. In some embodiments, once a stock is out of balance with respect to its target weight in the portfolio, the model may generate spreads of zero, i.e., mid-point bids or offers, for all sizes that reduce tracking error. In some embodiments, as an incentive, Aqua may offer a rebate of half a penny per share for any CCA midpoint order executed in the Aqua ATS; Aqua would deliver monthly rebate checks, per fund, to customers and each rebate would be contributed as cash to the CCA fund through whose ATS trading activity it was generated.

In some embodiments, the model may use midpoint prices, positions, target weights and covariance for stocks in the fund as well as overall risk tolerance and the maximum desired tracking error—all may be factors in calculating the premium. Target weights may be provided by each customer for each fund and updated nightly. In some embodiments, the covariance matrix is derived once each day from the Bs and Ds for (one or more or) all stocks in the fund that Quantal provide nightly. In some embodiments, ladders are sensitive to changes in risk tolerance; an optimal range of values may be determined by Quantal research.

In some embodiments, an exemplary system (e.g., CCA) Reservation Price Decision Engine may employ the following algorithm (and/or one or more components of this algorithm), e.g., to trade fund inventory with Aqua clients:
Invoke the Quantal reservation price model with preferred model parameters to generate a ladder of spreads and sizes for each name in the fund.
Send one ladder order per symbol and side to Aqua—for the nominal S&P 500 fund, this would mean 1,000 orders. These orders do not have an expiry time, i.e., the Aqua ATS treats them as day orders and may cancel them automatically at the end of the Aqua trading day if they are still active. In some embodiments, there may be some constraints on the maximum size in a ladder:
In some embodiments, the maximum size in a bid ladder for a stock shall be equal to no more than a configurable multiple (initially two) of the benchmark number of shares in that name and shall have a mark-to-market value of no more than some configurable percentage (initially 80%) of the cash value of the futures position in the fund.
In some embodiments, the maximum size in an offer ladder for a stock may be no more than the current total shares held in that name
If one or more of these orders trade then the resultant position changes are fed back into the model to generate new ladders for one or more names in the fund. To be clear, one trade in one name may cause the regeneration of all ladders for all names (or some portion thereof).
Each new ladder is compared with its currently posted ladder to see if there are any material differences between them that would make it useful to have the new ladder posted to the Aqua ATS. A material difference is defined as a change in the reservation quote of more than a quarter cent ($0.0025) on the first rung of the ladder where there is a non-zero change.
Any orders with materially different ladders are canceled and replaced with new ladder orders; those orders whose ladders are not materially different remain active in the Aqua ATS.
In the absence of any trades being received from the Aqua ATS in some configurable time interval, the decision engine may regenerate the ladders and employ the material difference comparison from step 4 to determine if ladders need to be reposted as a result of significant shifts in the midpoint price of a stock. CCA may like as long an interval as possible, say one minute, to avoid overburdening both the CCA and ATS systems. The time interval may be reset whenever an ATS trade occurs (step 3 above).

It may be better to have a policy rule whereby CCA continuously monitors the midpoint, but doesn't take action to change things unless there is a material difference—the downside is that the system would need to be able to cope with potentially large numbers of revisions within a minute if the market starts to move rapidly.

Note that in step 2.i above CCA may try to avoid buying more stock than CCA has cash to cover. In some embodiments, CCA may negotiate favorable deals with the larger brokerage firms that may allow CCA to swap a tranche of its holdings for cash inside the (T+3) settlement window.

In some embodiments, Reservation price trading may start when the Aqua ATS opens for business each day and ends at the Aqua end of day. In some embodiments, it is also possible to manually halt or resume reservation price trading in a single name, for an entire fund or customer, or all funds (or a portion thereof), and monitoring tools may be developed that allow CCA personnel to make such decisions.

Reservation price trading examples are described further herein.

Midsize Order Trading

In some embodiments, Aqua may use CCA inventory to post equity orders in an external limit order book such as Nasdaq's SuperMontage. In some embodiments, The orders may be posted on both sides of the book, as they are for ATS orders where the reservation spread ladder is generated for both bids and offers, for all stocks in the CCA fund universe. In some embodiments, To reduce the risk of adverse selection (where a trader or trading algorithm could detect and possibly game us), CCA may display anonymously on one side of the book, e.g., at all times. In some embodiments, the reservation spread ladder would be updated for both large and midsized orders after either a large or midsize trade. In some embodiments, CCA may not consider using the midsized order trading algorithm until Quantal has completed its research into adverse selection.

In some embodiments, midsized orders differ from ATS orders in that spread and size would be chosen by the Quantal model such that the orders show on the first “page” of the public limit order book at the largest size possible. Orders would be pegged to the midpoint plus a spread (defined by the Quantal model) and displayed as AQUA orders on one side (e.g., one side only). In some embodiments, by structuring the orders to fit on the first page with the name AQUA, Aqua would derive an advertising benefit as a by-product. In some embodiments, CCA may publish one-sided quotes for certain stocks if the reservation price model determines that CCA may be incurring too much tracking error as a result of trading activity in those names at any given time; CCA may revert to two-sided quotes once tracking error was back within an acceptable range.

In some embodiments, the external limit order book may optionally allow the system (e.g., CCA) to identify AQUA as the participant and may have sufficient depth in its public display that CCA's orders are visible on the first “page”. In the U.S., in some embodiments, SuperMontage may be the only choice of venue for midsized orders.

In some embodiments, If multiple funds wish to trade the same stock, CCA may deliver any shares traded to the fund for which the shares provide the greatest risk reduction or smallest risk increase.

Noise (Small Order) Trading

Noise trading may attempts to profit from small fluctuations in any stock's price in the intraday market. To the extent that block trades are nowadays broken down into sequences of small trades by trading algorithms, noise trading is a means of “accessing” this block-derived volume. Essentially, noise orders target the few cents of “noise” around the prevailing stock price in a flat market, i.e., when there is no persistent up or down trend in the stock price—in the instance where block trades are completed as a sequence of small trades, the cumulative impact of the sequence of small trades could result in the same transitory price pressure seen originally in block trades. Whenever noise orders trade, CCA may buy at a few cents below or sell at a few cents above the market best bid and offer at the time while hoping to keep its net position differential negligible or non-existent. In practical terms, noise orders are pairs of anonymous limit orders posted during normal market hours on both sides of an external limit order book, close to, but not at, the current midpoint price, in sizes of up to a few thousand shares. New prices and sizes are posted at some configurable interval, initially 15 seconds.

Note that, by design, noise orders are always resting orders—they may not take liquidity out of limit order books, in some embodiments. Most execution destinations offer incentives for liquidity-creating orders such as no-fee trading or rebates per share traded so in some embodiments CCA may be entitled to rebates which CCA could add to the cash in the fund from which the rebate-generating orders came.

In some embodiments, the outline of the noise trading model may be as follows:

In some embodiments, the system (e.g., CCA) may post quotes in the external market place. At the beginning of each 15 second interval (or other time period), bid and ask quotes may be posted in the external market place as follows: on the bid side, the quote may be set at N cents less than the best market bid; on the ask side, CCA's quote may be set N cents above the best market offer. N is set as a function of the stock's price; initially, N=2 cents.

In some embodiments, the bid and ask quotes may be held constant for up to 15 seconds (or other time period)—the quotes may not be changed even if the midpoint of the inside bid and ask quotes changes during the 15 seconds, and in some embodiments they may not be changed if the fund's inventory changes due to trades elsewhere in the 15 second interval.

In some embodiments, the system (e.g., CCA) may set an exogenous upper limit on the cumulative aggregate number of shares that can be executed on either side during the 15-second interval. Initially this upper limit is 5,000 shares. Starting from a neutral portfolio position, the limit is symmetrical: don't buy more than a net 5,000 shares or sell more than a net 5,000 shares in a 15 second interval.

In some embodiments, once a trade executes for the full size of either the bid or ask quote during the 15 second interval (or other time period), that quote is not replaced. If the order is only partially exercised, the unfilled portion remains active. The opposite side quote remains intact—if CCA were willing to do a trade at that opposite side quoted price previously, CCA would be a fortiori willing to do the trade after the opposite side trade.

In some embodiments, if both bid and ask quotes are taken out within the 15 second interval, CCA may still wait until the end of the 15 second interval before refreshing CCA's quotes.

In some embodiments, in the real-time implementation of the noise-trading algorithm, the reservation price model may be run at the end of each 15 second interval given the inventory positions for each of the 500 stocks at that time. With only the inventory cost component of the spread model, this size is likely to be large—potentially many tens of thousands of shares. In some embodiments, since CCA may want its maximum order size to be in the few thousand shares range, CCA may use the reservation price model only to inject an asymmetry into the bid and ask quotes for the next 15 second interval. To illustrate, suppose that CCA has accumulated a big positive inventory in a given stock—e.g., CCA has been hit on the one side in a long succession of 15-second intervals. Given the imbalance (and also taking into account the other 499 stocks), the reservation ask size (2 cents above the best ask) could be 5,000, but the reservation bid size (2 cents above the best bid) is only 100 shares.

In some embodiments, there may be a small option value given up in maintaining CCA's quotes for 15 seconds—that is, the system (e.g., CCA) may give the crowd the right to buy shares from the system, or sell shares to the system, at the fixed quote price (“limit price”) if the market moves during the 15 seconds. The value of the option depends upon the volatility of the midpoint over the 15 seconds. It is likely to be small.

In some embodiments, an obvious question may be whether the noise trading model causes CCA to have ex post “regret” if prices turn out to have been trending. That is, suppose that the system (e.g., CCA) adjusts the bid and ask quotes every 15 seconds, that there is a trade of 10,000 shares during each of the 10 last intervals, and that the midpoint price has trended upward in every one of those last 10 intervals. With hindsight, would the system (e.g., CCA) have regret in not doing a trade in the first 15 second interval at the quoted prices appropriate to a 100,000 share trade; that is, could CCA's noise model be gamed by splitting a 100,000 order into 10 trades of 10,000 shares? The answer could be “no” if, counterfactually, the system (e.g., CCA) ignores the option value, i.e. adjust the bid and ask quotes during the 15 second interval whenever there is a move in the midpoint, and if the system (e.g., CCA) ignores other components of trading cost beside the inventory cost. The intuition is that the reservation price (spread) may be a linear function of size when only the inventory cost is taken into account. All else equal, in some embodiments it may not be possible to “game” a linear rule by breaking up a trade into smaller pieces.

The noise trading model may be tested, and heuristic rules developed, e.g., by simulated trading using the tick data, with the usual caveat that the market data would likely react to CCA's trades. The simulation looks at every trade in a given stock for June 2008. If CCA's quote within the 15 second interval is better than the respective quote most immediately preceding the trade, CCA may assume that CCA's fund would have done the trade. In the event of a tie between CCA's quote and the respective prior market quote, CCA may allocate the trade to the market or to the fund in proportion to quoted quantities; the rule for allocating ties may be incorporated as a changeable parameter in the simulation.

In some embodiments, the large-scale simulation may not (or in some embodiments may) use the inventory cost model to set bid and offer sizes at the end of each 15 second interval. Rather, sizes may be fixed and symmetrical. Also, in the simulation, each “trade” executed on the historical tick data is matched with an offsetting position in a futures contract so that CCA can see both the simulated total P&L and active P&L. One or more of the following may be parameterized in the simulation:

Length of interval (default=15 seconds) (or other time).

Spread increment (default=2 cents) (or other amount).

Total number of shares available to buy and sell (default=10,000, i.e., 5,000 shares per side) (or other amounts).

Tie breaking assumption as to who fills a quote when CCA's quote is equal to the quote at which an order was filled in the historical data.

Selection of an execution venue for noise trades may depend at least in part on one or more of the following criteria: Orders may be posted anonymously; the extent to which the venue can handle the throughput; the extent to which CCA will be rebated on these trades, and if so, by how much.

Market-On-Close Trading

CCA (Cantor Comparative Advantage, which in some embodiments may comprise an exemplary system and fund according to various aspects described herein) market-on-close (MOC) orders are designed to take advantage of end-of-day trade imbalances in the markets while simultaneously reducing the overall tracking error of a fund and locking in profits. MOC orders would only be posted to those markets whose imbalances are published electronically and that support MOC trading. In some embodiments, for U.S. markets today that means NYSE-listed names only.

The parameters of MOC orders may have one or more of the following features:
The Quantal model may determine the size and side of MOC orders that CCA may trade at the close;
In some embodiments, only NYSE MOC orders may be traded since Nasdaq MOC rules are more complicated. (In other embodiments, Nasdaq MOC and other order types may be traded, e.g., alternately or in addition.);
MOC orders could be based on the imbalances in each fund. CCA may generally only create sell orders in names with overweight positions in a fund and buy orders in names with underweight positions in the fund. In some embodiments, the MOC orders are based on the imbalances in each fund;
These MOC orders could be risk-reducing, but CCA might also create orders for the remaining imbalances if there were sufficient value available from a modest increase in risk. In some embodiments, the MOC orders are risk-reducing.
Since the market expects some portion of the imbalance to fill on the following day (because they represent demand that was not met today), CCA's willingness to correct these imbalances should result in additional positive alpha from the lack of the expected detrimental trading the market was expecting.

Futures Trading

Each customer fund may carry cash resulting from:
initial cash investment in the fund and subsequent increases (decreases) in cash investment;
profits from trading;
cash dividends; and
cash in the margin account held with CCA's or the system's futures broker.

This cash position may be reduced by equity and futures trading commissions and adjusted up or down by incoming and outgoing cash resulting from unsettled (T+2) equity trades, i.e., stock that CCA has nominally bought or sold but have not yet received or delivered. CCA may be notified of settlements by nightly uploads from each customer's back office systems.

In some embodiments, CCA or the system may apply equity trading commissions and rebates to each trade as it is executed. In other embodiments, CCA or the system may simply deduct brokerage fees from and add rebates to the fund on a monthly basis. If the former embodiment, CCA may store commission schedules in CCA's database or receive commissions and rebates in real-time from the execution destination. In the latter embodiment, CCA's customer may apply commissions and rebates to the fund overnight.

In some embodiments, to minimize cash drag, CCA may hedge all (or portion thereof) of the cash in the fund by buying futures that track the same benchmark that the customer fund is tracking. In some embodiments, this may mean S&P 500 futures contracts only.

In some embodiments, futures trading occurs in real-time whenever there is a surplus of cash or an increase in shares in the fund:
In some embodiments, when a fund is created, futures contracts may be bought to cover the cash position.
In some embodiments, when the fund is closed, all futures contracts (or a portion thereof) may be sold.
In some embodiments, when cash is increased or decreased, contracts may be bought or sold to correctly equitize the new cash position.

In some embodiments, contracts may be bought or sold at some configurable time intervals, for example, one, five, or ten minutes or another time frame. This small lag may help avoid situations where CCA may be constantly generating buy and sell orders that cancel each other out. In some embodiments, CCA may also choose to only buy or sell a predetermined minimum number of contracts at any given time. On any given day, CCA may buy and sell only the contract with the highest open interest at the beginning of the day or the end of the previous day. In some embodiments, CCA may always trade contracts at the market price. As contracts near their expiration date, say two weeks before the actual expiration, CCA may roll them forward to the next expiring contract by buying calendar spreads.

In some embodiments, CCA intends to trade futures electronically with a broker. In some embodiments, Brokerage firm selection may depend on one or more of the following factors:
In some embodiments, the system may trade regular S&P 500 futures contracts orders electronically. In some embodiments, the system may support e-Mini contract trading electronically.
In some embodiments, the system may trade S&P 500 futures calendar spread orders electronically. In other embodiments, it may not.
In some embodiments, the system may have CME pit brokers who receive the system's orders electronically.
In some embodiments, the system may receive real-time futures prices, futures contract closing prices, futures contract open interest at the close or the open, and other information, e.g., timely and from one or more sources of such data.

In some embodiments, the customer's of the system may be billed at various times (e.g., monthly) for futures trading commissions. In some embodiments, these charges may be deducted from cash in the customer's margin account.

Once established, the system (e.g., CCA) may be able to negotiate deals with the larger brokerage firms that may allow CCA to buy and sell futures free of charge in exchange for occasionally giving larger brokerage firms tranches of the system's (e.g., CCA's) holdings to trade. This may also give the system (e.g., CCA) alternative strategies for index reconstitution and provide CCA with a cash settlement vehicle.

Aqua ATS Implementation

The Aqua ATS (e.g., as described in at least one application incorporated by reference herein) may be modified to support the system's (e.g., CCA's) reservation spread trading. In some embodiments, the system may produce reservation spread ladders that ATS may use to generate firm orders to the buyside only.

Conditional Orders

ATS currently supports “Conditional” order functionality. Conditional orders represent a non-binding willingness to trade. Before a trade can take place the Conditional order may be “Firmed-Up”.

This Firm-Up takes the form of an invitation to send a Firm order for a particular Conditional order. The invitation can be accepted, by sending a Firm order or declined, by doing nothing. Failure to respond to the Firm-Up invitation in a timely manner also constitutes a decline of the Firm-Up invitation.

Irrespective of whether an invitation is accepted or declined, once an invitation to Firm-Up has been issued for a Conditional order, the Conditional order is implicitly cancelled i.e., no cancel acknowledgement is sent for the Conditional order.

In some embodiments, executions (Trades) will be done against a Firm order, and not against a Conditional order. (In other embodiments, executions may be done against other orders.)

CCA Conditional Ladder Orders

In some embodiments, the system (e.g., CCA) may use Conditional “Ladder” orders as the ability to accept or decline a Firm-up provides the system (e.g., CCA) with a risk management tool. In some embodiments, the system (e.g., CCA) may decide whether to accept or decline a Firm Up on an invitation-by-invitation basis. In some embodiments, If the invitation is accepted the system (e.g., CCA) may send a Firm order for the symbol, side and quantity specified in the invitation. In some embodiments, If the invitation is declined the system (e.g., CCA) may subsequently send a new Conditional order which may or may not have ladders materially different from the preceding Conditional order.

In some embodiments, the system's (e.g., CCA) Conditional orders may not have a price. Instead the orders may have a “Ladder”, the rungs of which may represent a price offset above/below the mid-point for a given quantity. In some embodiments, each order may have a maximum number of shares which it is willing to trade.

The price for a Sell order is the current mid-point plus the offset for the given quantity. For a Buy order the price is the mid-point less the offset for the given quantity. The offset is typically in cents, and may be 0.

There is a time window between pricing the order for display and execution. To prevent gaming no trade should be allowed if the mid-point has changed by a threshold, such as 2 or more cents since the order was priced.

Firm Order Matching Server

When the FMS receives a ladder order, it may initiate a “go fish” for the named stock, forwarding the ladder order to all Aqua Participant Servers (or a portion thereof). It also adds the ladder order to the list of live orders for the named fund. The FMS should reject ladder orders when an existing ladder order exists for the same stock and fund name Note that conditional ladder orders are day orders and therefore live until they are either Firmed Up, are canceled by the system (e.g., CCA), or the ATS closes for the day, whichever comes first. If a ladder order is still live when ATS closes for the day, the ATS may send an unsolicited cancel acknowledgement back to the system (e.g., CCA) with a reason “Done for Day”.

When a Conditional order is Firmed-up, and the Firm order is filled, the FMS sends an execution report for the Firm Order to the system (e.g., CCA) giving the price, size and side of the trade for the named stock and fund and the mid-point price from which the trade price was derived.

If the FMS receives a cancel request for a conditional ladder order, it may either acknowledge the request or reject it if the order is has been Firmed Up, if it has expired (the ATS has already closed for the day), e.g., if is less than 30 seconds old, if it contains a duplicate request ID or if the target order ID is unknown to ATS. If the cancel request is acknowledged, FMS marks the order as canceled. In some embodiments, one or more or all subsequent trade notifications received from Participant Servers against the order may be rejected “Traded Ahead”.

Aqua Participant Server

In some embodiments, when an APS receives a ladder order, it may check to see if any Aqua users are eligible to view that name on that side for up to the maximum number of shares CCA is willing to trade on that side. In some embodiments, if no-one is eligible, the ladder order is ignored. Otherwise, in some embodiments, for each eligible user, the APS may take one or more of the following actions:
take a snapshot of the current NBBO;
derive the midpoint price from the NBBO;
get the size of the user's contra side order;
set the size to offer the user as the minimum of the user's size and the maximum size CCA is willing to trade;
look up the spread that CCA is prepared to offer at the offered size; initially, this may be derived by simple linear interpolation between the sizes around either side of the offered size, the resultant spread being rounded up or down to the nearest Aqua ATS minimum price increment (one penny currently);
if the offered spread is zero, deliver the normal midpoint notice to the user's Aqua UI; otherwise,
compute a stop limit price as the midpoint price plus the offered spread (zero or negative for bids and zero or positive for offers);
create a notice containing the symbol, side, size, spread and stop limit price;
store the notice information and the spread and stop limit price associated with it; and
send the notice to the user's Aqua UI.
In some embodiments, If a user accepts the CCA offer within the shot clock time, the Aqua UI sends a trade notification back to the APS, which may then do one or more of the following actions:
take a snapshot of the current NBBO;
look up the notice information and the spread and stop limit price associated with it;
derive the midpoint price from the NBBO;
compute a trade price as the midpoint price plus the spread from the notice information;
compare the trade price with the stop limit price set when the notice was generated;
If the trade price does not meet the stop limit price, i.e., the trade price is higher than the bid limit or lower than the offer limit, the APS may reject the trade; otherwise
APS may forward the trade notification back to FMS.

Aqua UI

In some embodiments, When the Aqua UI receives an Aqua notice for a the system (e.g., CCA) ladder order from the Participant Server, it starts a shot clock and displays the Aqua notice in a popup window on the user's desktop. In some embodiments, the popup may display all the information the UI currently displays for non-CCA orders and in addition it may show the premium above, or discount below, the midpoint that the system (e.g., CCA) is willing to accept for the size the trader wishes to buy or sell.

In some embodiments, if the user decides to accept the CCA offer within the shot clock, the Aqua UI may send a trade notification back to the Participant Server, as it does for any accepted offer.

Market Data

In some embodiments, since Aqua may be responsible for deriving a midpoint price with which to price CCA's firm orders, Aqua may need to be especially fast and accurate with market data.

CCA Firm Order Notices to the Sellside

As stated previously, Aqua may initially send notices of the system (e.g., CCA) firm orders to the buyside only. In some embodiments, Aqua will create sellside notices of the system (e.g., CCA) firm orders. In some embodiments, since the size of a sellside order may already be known, pricing may be simply a matter of deriving the midpoint price and adding or subtracting the spread at that size and side.

CCA Trading Support

In some embodiments, the system (e.g., CCA) may employ at least one qualified trader who may be responsible for ensuring that the system (e.g., CCA) trading system is not generating losses for the system (e.g., CCA) by:
suspending and resuming trading in certain stocks and/or certain trading algorithms when:
stocks or algorithms are making a loss;
there are external events such as company news or corporate actions.
manually interacting with the markets to trade back into balance.
In order to meet these responsibilities, the trader may need a tool to monitor and control the system (e.g., CCA) trading system and probably a separate tool to interact with the equity markets.
In some embodiments, the system (e.g., CCA) trader may need to see at least the following information in real-time for every fund:
Realized tracking error.
Predicted tracking error.
P&L for the fund itself.
Market data for any name in a fund (BBO, last trade, net change, volume, open, high, low).
News related to any name in the fund (provided by a Bloomberg Terminal).
S&P 500 composite price and net change.
Over/underweight indicators for each name in a fund.
Gain/loss indicators for each name in a fund. This would indicate the relative losses or gains caused by trading each stock since the beginning of each day.
Time & Sales for each name today.
Cash and futures positions.
   To enhance the trader's capability, Quantal may research electronic news filtering that can process a much bigger data feed than could a human. In comparing algorithms and human judgment, particular emphasis may be placed on the relative levels of Type I and Type II error rates, i.e. how often is trading suspended when it is a “false alarm” versus how often is trading not suspended when, in fact, something significant was happening to the stock.

Position Management

In some embodiments, position management feeds the trading models, the UI that the system (e.g., CCA) trader uses to monitor model performance and the systems that generate P&L reports for the system's (e.g., CCA) customers and its business teams.

In some embodiments, the Position Management System may:
record all trading activity and position updates (or a portion thereof) without losing a single trade.
feed position updates to the trading algorithms in real-time.

Profit and Loss Accounting and Reporting

The system (e.g., CCA) may employ an accounting system that calculates profit and loss by fund to a high degree of accuracy and provides daily reports to the business team and periodic reports to its customers.

The dollar value or net asset value (NAV) of a fund may be equal to the sum of the following:
Equity holdings marked to the closing price for each name in the fund.
S&P 500 futures contracts marked to the closing price of each contract held.
The cash value of unsettled equity trades, either a negative amount for purchases or a positive amount for sales.
Cash in the futures margin account.
Are futures trading commissions deducted from this cash or is CCA billed monthly?
Residual cash, i.e., cash not covered by S&P 500 futures contracts and optimally less than the value of one S&P 500 futures contract marked to the previous day's closing price.

In general, profit (loss) for any fund between any two inclusive dates can be calculated as follows:
1. Calculate the fund's NAV on the start date using closing prices from the previous business day.
2. Convert the dollar value from step 1 into equivalent benchmark index holdings on the start date given the published index weights provided by the customer for the start date and the closing prices from the previous business day. This represents the benchmark portfolio for the period, with the smallest possible cash position.
3. Calculate the fund's NAV on the end date using closing prices for the end date.
4. Mark the benchmark portfolio from step 2 to market using closing prices for the end date.
5. The NAV of the actual fund from step 3 less the NAV of the benchmark fund may comprise the active profit (loss) in dollars from the supplied start date to the supplied end date.

In some embodiments, system may keep a running decomposition of how much active P&L is coming from spreads on transactions and how much is coming from mark-to-market gains on under- or over-weight positions.

In order to calculate P&L between any two dates upon request, the system (e.g., CCA) may want to archive real positions, target (benchmark) positions, cash positions and closing prices for all stocks and futures contracts in the fund at the end of every business day (or a portion thereof). In some embodiments, it may allow CCA to monitor fund performance and provide audit trails for diagnostic and reporting purposes. The system (e.g., CCA) may calculate and store actual and benchmark NAVs for each fund at the end of every business day. This is primarily because the weights change every day as individual stock prices change. It also means that customers can adjust fund holdings at any time without affecting the system's (e.g., CCA) P&L calculations. This is actually the simplest and most accurate way to track P&L and it means that the system (e.g., CCA) can report P&L for any period simply by summing the daily NAVs and subtracting the total actual from the total benchmark and dividing by the total number of days.

In some embodiments, the information in the aforementioned P&L may be used to disaggregate the gross trading revenue (GTR) component of P&L for the business day. The disaggregation may enable the system to determine how much of GTR is due to revenue from round-trip transactions, how much is due to mark-to-market gains/losses on beginning-of-day inventory, and how much is due to mark-to-market gains/losses on changes in inventory during the day—this last item is a first-cut signal of potential adverse selection and/or predatory trading. This disaggregation of daily GTR is now explained:

The fund's Gross Trading Revenue on stock i for period t may be written as GTRᵢₜ. To make it simple, period t is set to be a trading day in what follows. GTRᵢₜ is defined to be:

GTRᵢₜ=(Sᵢₜ−Bᵢₜ)+(pᵢₜIᵢₜ−pᵢₜ₋₁Iᵢₜ₋₁)

where:

Sᵢₜ is the amount earned when the fund sells stock i (i.e. the crowd buys);

Bᵢₜ is the amount earned when the fund sells stock i (i.e. the crowd sells);

pᵢₜ is the price of stock i at the end of day t; pᵢₜ₋₁ is the price of stock i at the beginning of day t (end of day t−1); and

Iᵢₜ is the fund's inventory of stock i (in shares) at the end of day t.

This expression simply states that Gross Trading Revenue on the stock over the day is equal to the net cash flows on the sells minus the buys, plus the mark-to-market gain or loss on inventory position in the stock. Hereafter, the subscript i may be dropped, and it can be understood that the analysis applies to stock i.

The dollars from sales of stock can be conveniently written as:

Sₜ=sₜ·p̅ₜ^{s}
where sₜ is the shares on stock sold (crowd buys) from the fund during the day and p̅ₜ^{s} is average ask price on those shares that are sold. Similarly:

Bₜ=bₜ·p̅ₜ^{b}
where bₜ is the shares on stock bought (crowd sells) by the fund during the day and p̅ₜ^{b} is average bid price on those shares that are bought.

Substituting for Sₜ and Bₜ in the expression for GTRₜ

GTRₜ=(sₜp̅ₜ^{s}−bₜp̅ₜ^{b})+pₜ(Iₜ−Iₜ₋₁)+Iₜ₋₁(pₜ−pₜ₋₁)

Now min(sₜ,bₜ) is the number of round-trip shares bought and sold. Substituting this into the preceding expression for Gross Trading Revenue gives:

GTRₜ=min(s,b)(p̅ₜ^{s}−p̅ₜ^{b})+p̅ₜ^{s}(sₜ−bₜ)⁺−p̅ₜ^{-b}(bₜ−sₜ)⁺+pₜ(Iₜ−Iₜ₋₁)+Iₜ₋₁(pₜ−pₜ₋₁)

Also:

Iₜ=Iₜ₋₁+(bₜ−sₜ)

So:

GTRₜ=min(sₜ,bₜ)(p̅ₜ^{s}−p̅ₜ^{b})+(pₜ−p̅ₜ^{b})(bₜ−sₜ)⁺+(p̅ₜ^{s}−pₜ)(sₜ−bₜ)⁺+Iₜ₋₁(pₜ−pₜ₋₁)

The first term in this expression is the round-trip trading revenue.

The second and third terms are the mark-to-end-of-day market profits on changes in inventory during the day. Note that these two terms are the ones that may give an indication of whether there was adverse selection or predatory trading in these changes in inventory, e.g. if pₜ<<p̅ₜ^{b} on a day when inventory was piling up in the fund (bₜ−sₜ)⁺, it is an indication that an informed crowd was selling to CCA or CCA may face predatory trading.

The third term in the expression is the mark-to-market gain for the day on the shares of the stock that were held by the fund at the beginning of the day.

In some embodiments, the system may adjust the prices for commissions, rebates etc. to try to get closer to a Net Trading Revenue number.

The system (e.g., CCA) may be assessed and remunerated for performance compared to a benchmark index. It is straightforward to adjust the Gross Trading Revenue to be that in excess of the return on the S&P 500 Index. That is because there is no trading in the index. Thus, for the given stock, the third term, the inventory gain or loss, simply needs to be restated as the gain or loss in excess of the index. Thus, the third term simply becomes the gain or loss on the active position in the given stock held by the fund at the beginning of the day.

GTRₜ=min(sₜ,bₜ)(p̅ₜ^{s}−p̅ₜ^{b})+(pₜ−p̅ₜ^{b})(bₜ−sₜ)⁺+(p̅ₜ^{s}−pₜ)(sₜ−bₜ)⁺+(Iₜ₋₁−Iₜ₋₁*)(pₜ−pₜ₋₁)
where Iₜ₋₁* is the number of shares of the S&P 500 in the given stock. Note that the variation over time in the last term is an approximation to the realized dollar tracking error.

The preceding applies to the Gross Trading Revenue over a given day. However, the calculation for gross (or approximate net) trading revenue, and its decomposition, could also be computed cumulatively during the day—the inputs would be cumulative shares bought and sold since beginning of day, average buy price and sell price on trades since beginning of day, etc.

It is easy to imagine that it would be useful to further slice-and-dice the revenue across stocks and across trades, to see where profits or losses are being made and perhaps to diagnose problems. The system (e.g., CCA) could try to program in this slicing-and-dicing, or use something like JRisk which already has that capability.

P&L may be reported (e.g., by the system) for each fund to its respective customer on a schedule that fits in with the customer's monthly, quarterly and/or annual reporting cycles. The system (e.g., CCA) may request these cycles from each customer.

Each P&L report may contain some combination of the following columns/rows:
Customer contributed stock and cash positions at the beginning of the reporting period.
Customer adjustments to stock and cash positions (additional contributions, profit-taking).
Corporate actions (splits and dividends).
Actual stock and cash positions at the beginning of the reporting period.
Actual stock and cash positions at the end of the reporting period.
Tracking error at the start and end of the reporting period.
Benchmark performance for the period in dollars profit (loss).
Fund performance for the period in dollars profit (loss).
Overall profit (loss) for the period.

Reconciliation

In some embodiments, each night there may comprise a number of back office reconciliation processes implemented for each customer. These may comprise:
clearing (e.g., a customer may notify the system (e.g., CCA) when an equity or futures trade settles or when there are breaks);
notifications of the system's (e.g., CCA) current cash, equity and futures holdings per fund;
notification of the system's (e.g., CCA) derived fund and benchmark NAVs; and
notification of any additional or reduced equity and cash at the beginning of each trading day from:
   a. additional investments in the fund;
   b. overnight interest earned by cash holdings in the fund;
   c. profit taking;
   d. equity and futures trading commissions and rebates;
   e. corporate actions.

In some embodiments, the system (e.g., CCA) may archive the following each business day:
all inputs to the model (or a portion thereof);
all orders and trades (or a portion thereof);
closing prices; and
benchmark and actual weights and NAVs.

This may allow CCA to recreate all ladder trading scenarios and P&L at any time.

Surveillance

In some embodiments, Aqua may provide a surveillance system that simply records in every Aqua trade the midpoint price one minute after the trade was executed. In some embodiments, if on average for a participant, the price at which they traded and the one minute midpoint differ by the amount of the premium or discount demanded by CCA, that participant may be placed in a high risk pool. CCA (or any other Aqua participant) may then instruct Aqua that CCA does not wish to display CCA's orders to any participant in the high risk pool. The extension of this idea, i.e., monitoring the price post-trade, is one of the ways CCA are measuring potential adverse selection costs. For example, if the information possessed by an informed trader is released later in the day, CCA would want to look at the difference between the trade price and the end-of-day price: on average, prices may go down (up) after CCA has bought (sold) from (to) an informed seller (buyer).

Key Factors Affecting Technology

This section outlines the real world factors that may most influence the decisions CCA makes about the technology CCA may use to implement the CCA product. These real world factors do not necessarily impact various embodiments of the invention described herein.

Business Continuity

In some embodiments, the design, planning and implementation of business continuity processes like redundant servers and data centers can be costly. Since CCA can stop trading for any reason when and if CCA chooses, CCA can extend this principle to business continuity. If CCA's systems go down because of hardware or site failure, CCA should be able to wait it out until servers are back online—there is no cost to CCA being down for a short time, provided that CCA's funds still closely track their benchmarks.

Since CCA would like its database for reconciliation purposes every night, the database may be replicated either in real-time or batch mode from Trumbull to Rochelle Park. The replicated database also allows CCA to perform database-intensive queries intraday without impacting the performance of the production system.

Database Design and Performance

In some embodiments, CCA needs to be able to know its fund positions with 100% accuracy at substantially all times so CCA's database implementation should be highly resilient. In some embodiments, any database failure may result in all CCA trading activity being halted.

In some embodiments, For the universe of S&P 500 stocks, the noise decision engine may publish 500 bid and 500 offer orders every 15 seconds. In some embodiments, If CCA assumes an average trade size for liquid stocks of 250 shares and a typical noise order size of 1,500 shares, CCA can potentially generate six trades per order or a total of 6,000 trades in a 15 second period. This corresponds to 1,000 order table inserts, 6,000 trade table inserts and 6,000 position table updates in 15 seconds, or a total of 867 transactions per second, which is high. It is therefore possible that CCA may want to reach a compromise between the desired noise trading interval and the amount CCA spends on database hardware and software.

In some embodiments, large order trading can potentially also generate a significant number of database writes, depending on how it is implemented. One idea that has been discussed is that in some embodiments, CCA may only stores noise or ladder orders in the database if and when they trade and have suggested the same approach to Aqua. This approach for large orders may actually allow CCA to reduce the refresh interval below the one minute suggested in CCA's description of the large order trading algorithm (see above).

Noise Trading Performance

In some embodiments, noise trading may generate a thousand orders in S&P 500 names every 15 seconds. CCA may need to stress test with its execution destination to ensure that they both have the necessary throughput—CCA can always reduce the interval to something that is manageable by both parties.

DirectEdge claim that they are used to handling this kind of trading style. Bloomberg Tradebook has a special order type, frequency peg, that allows you to specify a spread from the midpoint and a refresh interval. Tradebook calculates a limit price from the spread when it receives a frequency peg order and at each refresh interval, until the order is canceled.

Market Data

In some embodiments, the principal consideration for real-time level 1 market data is latency—the faster CCA gets market quotes and trades into the trading models, the faster they can respond to changing market conditions. Ideally, CCA may need:
a data vendor who offers the lowest possible latency from the data source (NYSE, Nasdaq) to its data centers.
the ability for CCA to collocate CCA's market data servers with the data vendor's product on the same physical machine or on the same low latency local area network.
minimum latency between CCA's market data servers and the decision engines that consume market data.

In some embodiments, the end-to-end latency from a market data source to CCA's decision engines may be 20 ms or less. Initial discussions with Xasax, who provide high speed networking and collocation services, indicate that it takes about 4-5 ms to deliver market data from its source to Aqua's Market Data Servers.

While there would be a latency advantage to be gained by collocating the decision engines on the same physical hardware as the Market Data Servers, the total latency incurred by locating them at Trumbull is still significantly less than CCA's target of 20 ms. There are other good reasons to locate the decision engines in Trumbull, such as data security considerations (see below) and collocation with the database and position servers.

Data Security

The need for high throughput and minimal latency between market data sources and the decision engines motivates CCA to locate the decision engines at Xasax′ data center. However, the decision engines transmit sensitive data—orders and trades as well as model parameters such as risk tolerance—to the position system and the database which may both reside at Trumbull for performance and security reasons. So either the transmission of sensitive data may be encrypted using a secure transport like SSL, or the decision engines may also be located at Trumbull so that only non-sensitive (i.e., market) data would be transmitted to Trumbull and no sensitive data would reside outside of the Cantor network.

For these reasons described herein, the system may run the Market Data Servers in some places and run all CCA software inside the Cantor data center. CCA may also order a leased line from one area to deliver market data from other places with the lowest possible latency.

High-Level Architecture

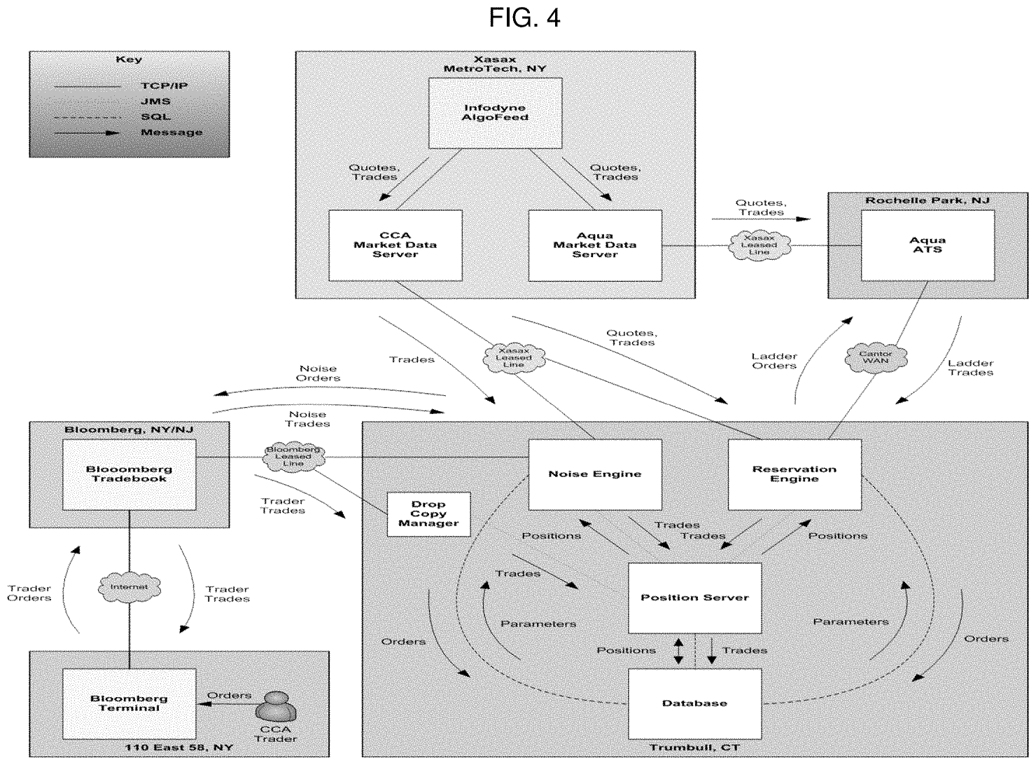

FIG. 4 depicts an exemplary system architecture according to at least one embodiment of the systems disclosed herein.

Reservation Price Model

This appendix explains the derivation of the inventory cost component of the reservation price model for a specific trade based on tracking error (according to various embodiments), and “maps” the derivation to the Matlab code.

The Mathematical Model

Assume that the fund size (i.e., total cash value) is F and there are N securities. Let w be the portfolio position vector (Σᵢ₌₁^{N}wᵢ=1) and y be the vector of index weights (Σᵢ₌₁^{N}yᵢ=1). The tracking error cost (expressed in terms of an annualized return cost) of holding a deviation of w−y for time duration τ is:

$$\frac{1}{ρ} {( w - y )}^{′} V ( w - y ) τ$$

where V is the variance/covariance matrix and ρ is the tracking error tolerance.

Now assume we want to calculate the reservation price adjustment for a specific trade of size s shares in stock j, where the sign of s is negative if the trade is a customer buy (CCA or the system is selling) and positive if it is a customer sell (CCA or the system is buying). Let Pⱼ be the (unadjusted for tracking error risk) price of stock j. It follows that after the trade the new portfolio vector will be w+δ where:

$${δ}_{i} = \{ \begin{matrix}0 & if i \neq j \\ \frac{{sP}_{j}}{F} & if i = j\end{matrix}$$

The change in tracking error risk is:

$$change in TE risk = \frac{1}{ρ} [ {( w + δ - y )}^{′} V ( w + δ - y ) - {( w - y )}^{′} V ( w - y ) ] τ = \frac{1}{ρ} [ 2 {δ}^{′} V ( w - y ) + {δ}^{′} V δ ] τ \qquad ( 3 )$$

Now define λⱼ=[V(w−y)]ⱼ. In other words, λⱼ is the jth element of the vector V(w−y). Define θⱼ=V_{j,j}. This means that θⱼ is simply the active variance of stock j. We then have:

$$change in TE risk = \frac{τ}{ρ} [ 2 {λ}_{j} \frac{{sP}_{j}}{F} + {{θ}_{j} ( \frac{{sP}_{j}}{F} )}^{2} ] \qquad ( 4 )$$

Now (4) gives the change in tracking error risk in terms of return. The dollar value of this will be (4) multiplied by the fund size F. In some embodiments, this may be the minimum amount needed to recover from the trade to make CCA willing to execute the trade. In some embodiments, if this amount is negative (a risk-reducing trade), this may be the maximum amount CCA or the system would be willing (in a reservation cost sense) to pay for the trade to take place (i.e., the maximum CCA or the system would pay to subsidize the trade).

The reservation price increment multiplied by s (the dollar adjustment for the trade) may then equal the dollar value obtained by multiplying (4) by F. That is:

$$reservation increment Δ = - ( \frac{F}{s} ) \times \frac{τ}{ρ} [ 2 {λ}_{j} \frac{{sP}_{j}}{F} + {{θ}_{j} ( \frac{{sP}_{j}}{F} )}^{2} ] = - \frac{τ}{ρ} [ 2 {λ}_{j} {P}_{j} + \frac{{θ}_{j}}{F} {sP}_{j}^{2} ] \qquad ( 5 )$$

Note that signs in (5) may be explained. Given the convention that s is negative when the customer is buying and positive when the customer is selling, we may reverse the sign. Note that the second term of (4) is always positive and money may be recovered (e.g., always or sometimes) to account for this. Thus, in some embodiments, when s is sufficiently negative and the customer is buying, CCA or the system may be adding to the price; and when s is sufficiently positive and the customer is selling, CCA or the system may be subtracting.

Now consider the trade sizes at which the price is incremented by a specific reservation increment equal to Δ. Solving for (5) for s as a function of Δ, we have:

$$s ( Δ ) = - \frac{F}{{θ}_{j} {P}_{j}} ( 2 {λ}_{j} + \frac{ρ {Δ}_{j}}{τ {P}_{j}} ) \qquad ( 6 )$$

The Implementation

Implementing the mathematical model involves the implementation of the above calculations in the Matlab programming languages.

The InitialiseBandD routine. This routine implements the calculation of the value V (with the b and d capitalized in the Matlab code):

V=(b′b+d)

The Matlab code is:

B=temp.data(:,1:30);

D=temp.data(:,31);

QuantalB=(252\hat{ }0.5)*B;

QuantalD=(252)*D;

QuantalTotalSecurityVariance=sum(QuantalB.*QuantalB,2)+QuantalD;

The InventoryImbalanceCoefficents routine. This routine implements the calculation of the constant factor and the slope for the inventory risk specified in equation 5 as:

$$Decay = 1 / τ$$

$$InventoryRiskConstant = \frac{2 λ τ}{ρ} and InventoryRiskSlope = \frac{θ τ}{F ρ}$$

The Matlab code is:

Decay=252./ExpectedHoldingPeriodInDays;

InventoryRiskConstant=QuantalB′*(PortfolioWeights−IndexWeights);

InventoryRiskConstant=QuantalB*InventoryRiskConstant+QuantalD.*(PortfolioWeights−IndexWeights);

InventoryRiskConstant=2*InventoryRiskConstant./(RiskTolerance*Decay);

InventoryRiskSlope=QuantalTotalSecurityVariance./(FundSize*RiskTolerance*Decay);

The MarginalPriceSizePoints routine. The routine implements the calculation of the symbol Δ and the symbol s(Δ), corresponding to the variable MarginalPricePoints and SizePoints respectively, specified in equation 6 above as

$$Δ = - InventoryRiskConstant \times P - InventoryRiskSlope \times {P}^{2} \times Size$$

$$Size = - \frac{Δ + InventoryRiskConstant \times P}{InventoryRiskSlope \times {P}^{2}}$$

The Matlab code is:

MarginalPricePoints=

repmat((0:1:NumberOnEachSize),size(Price,1),1).*repmat(PriceIncrements,1,Number OnEachSize+1);

MarginalPricePoints=[fliplr(−MarginalPricePoints) MarginalPricePoints(:,2:end)];

SizePoints=

(MarginalPricePoints+repmat(InventoryRiskConstant.*Price,1,2*NumberOnEachSize+1))

./(repmat(InventoryRiskSlope.*Price.\hat{ }2,1,2*NumberOnEachSize+1));

SizePoints=round(SizePoints);

Noise Trading Examples.

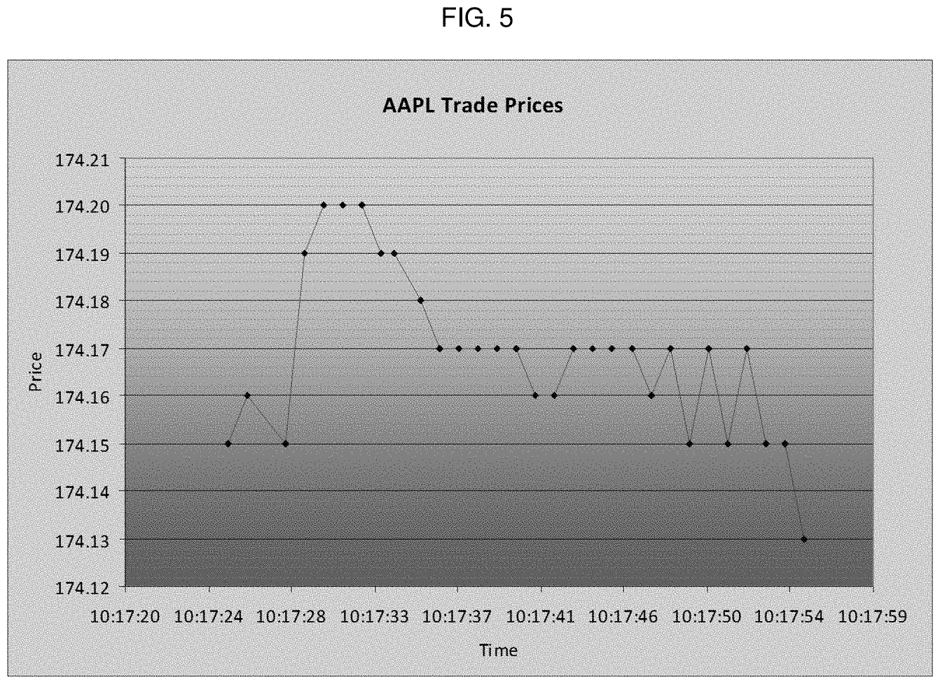

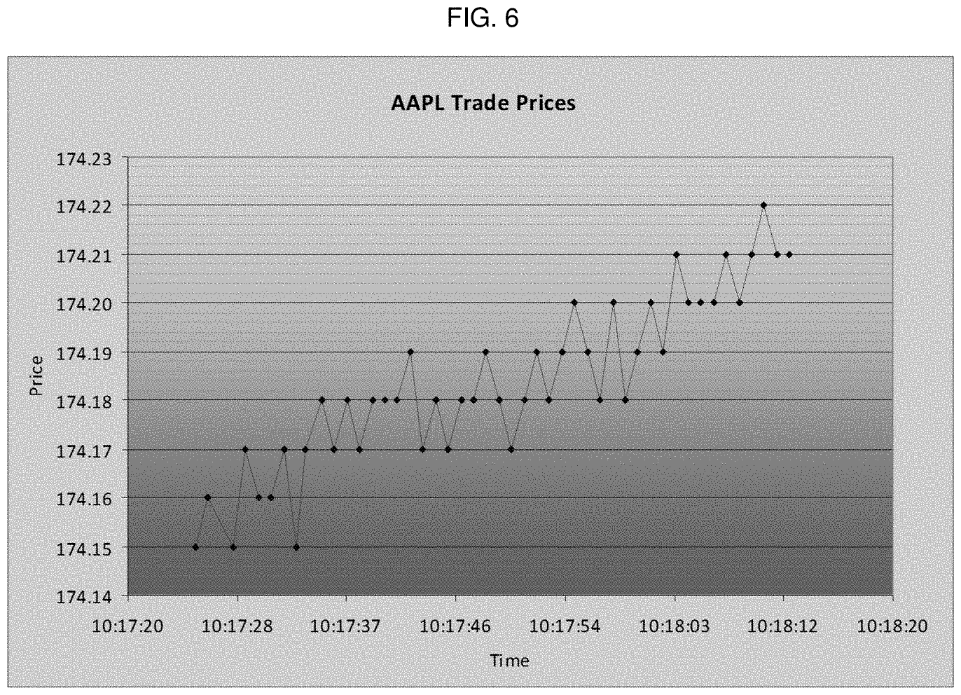

FIGS. 5-6 illustrate information related to noise trading examples.

The noise trading examples shown in FIGS. 5-6 use a noise order spread of ±2 cents from the bid/offer and an initial size of 1,500 with adjustments of ±500 shares per interval depending on the net long or short position of AAPL. These parameters illustrate how noise trading works. The examples also assume that 250 shares are available at each trade tick.

FIG. 5: Trading AAPL in a Non-Trending Market. In the example shown in FIG. 5, the average price of Apple stock stays constant over a one minute period.

1. At 10:17:24, midpoint price is $174.17, two orders entered: BY 1,500 @ 174.15, SL 1,500 @ 174.19.

2. 250 shares bought at 10:17:25 and :28, 250 shares sold at 10:17:29, :30, :31, :32, :33 and :34.

3. Orders expire at 10:17:39, net position short 1,000, net profit (174.19−174.15)×500=$20.

4. At 10:17:39, midpoint price is still $174.17, two orders entered: BY 2,000 @ 174.15, SL 1,000 @ 174.19.

5. 250 shares bought at 10:17:49, :51, :53 and :54.

6. Orders expire at 10:17:54, net position zero, net profit $20+$(174.19−174.15)×1,000=$60.

7. At 10:17:54, midpoint price is $174.15, two orders entered: BY 1,500 @ 174.13, SL 1,500 @ 174.17.

FIG. 6: Trading AAPL in a Trending Market. In the example of FIG. 6, the average price of Apple stock increases slightly over a one minute interval.

1. At 10:17:24, midpoint price is $174.15, two orders entered: BY 1,500 @ 174.13, SL 1,500 @ 174.17.

2. 250 shares sold at 10:17:29, :32, :33, :34, :35 and :36.

3. Sell order is filled at 10:17:36, buy order is canceled. Net position short 1,500, no realized profit.

4. At 10:17:36, midpoint price is now $174.17, two new orders entered: BY 2,000 @ 174.15, SL 1,000 @ 174.19.

5. 250 shares sold at 10:17:48, :52 and :54.

6. Orders expire at 10:17:54, net position short 2,250, no realized profit.

7. At 10:17:54, midpoint price is now 174.19, two orders entered: BY 2,500 @ 174.17, SL 500 @ 174.21.

8. 250 shares sold at 10:18:03 and :07.

9. Sell order is filled at 10:37:07, buy order is canceled. Net position short 2,750 shares, no realized profit.

10. At 10:37:07, midpoint price is now $174.21, one new order entered: BY 3,000 @ 174.19. No further sell orders are issued until market drops hits $174.19, either as noise by holding the stock price at $174.21 or by reversing the upward trend.

Reservation Price Trading Examples.

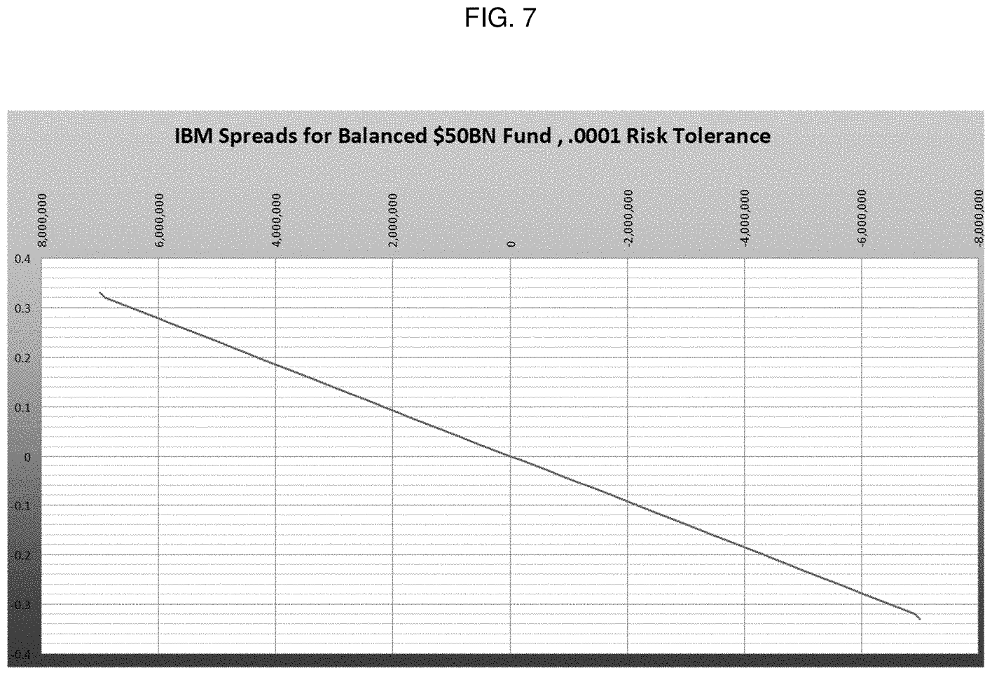

FIGS. 7-10 illustrate information related to reservation price trading examples.

The following examples demonstrate how reservation price trading works. The first example shows a reservation spread ladder for IBM assuming that IBM is in balance in the fund for which the ladder is generated. The second example continues from the first and demonstrates how the model skews the ladder to favor midpoint trades (i.e., zero spreads) to reduce or eliminate an imbalance.

Trading IBM when in Balance in a Fund.

The ladder of FIG. 7 may be generated when IBM is in with respect to its target weight in a $50BN S&P 500 index fund:

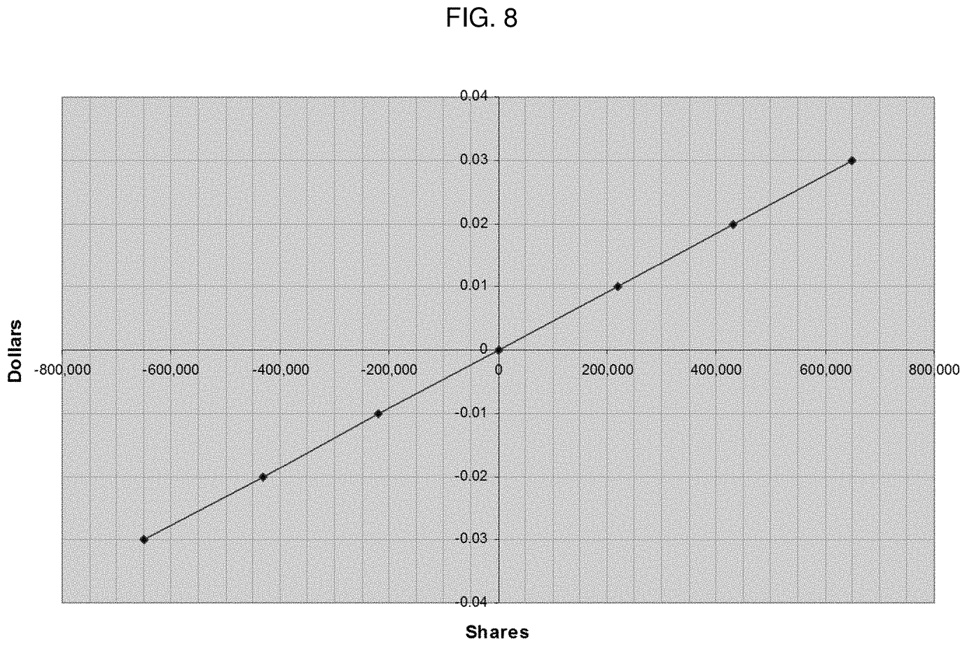

FIG. 8 depicts a graph showing the first few steps of the ladder of FIG. 7. As shown in FIG. 8, the graph is symmetrical about the origin, (0, 0):

Trading IBM when Out of Balance in a Fund.

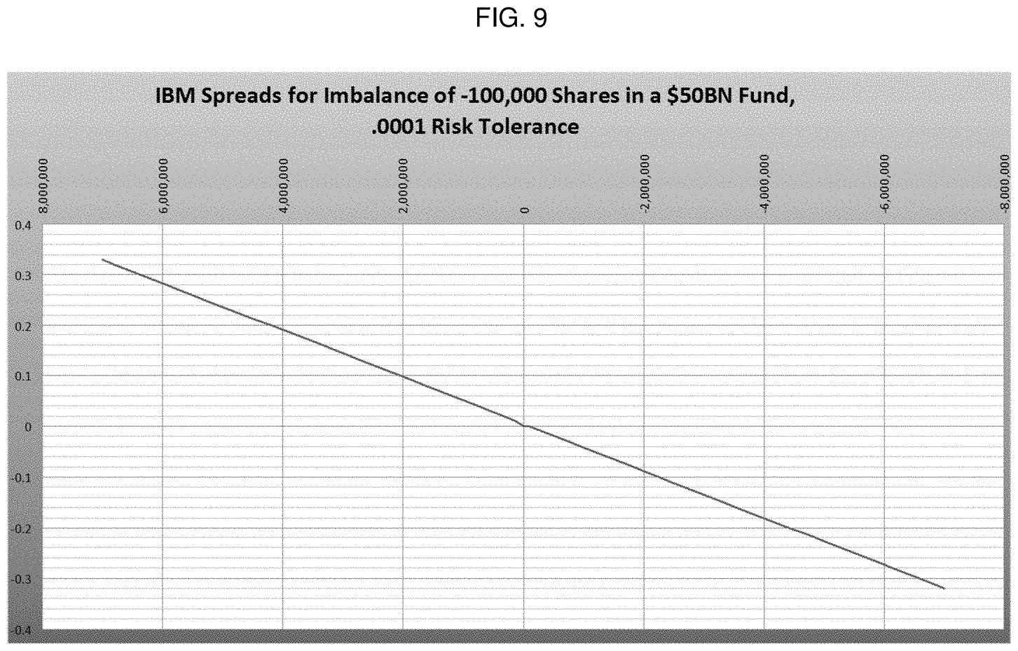

The ladder of FIG. 9 may be generated when IBM is out of balance by −100,000 shares with respect to its target weight in a $50BN S&P 500 index fund.

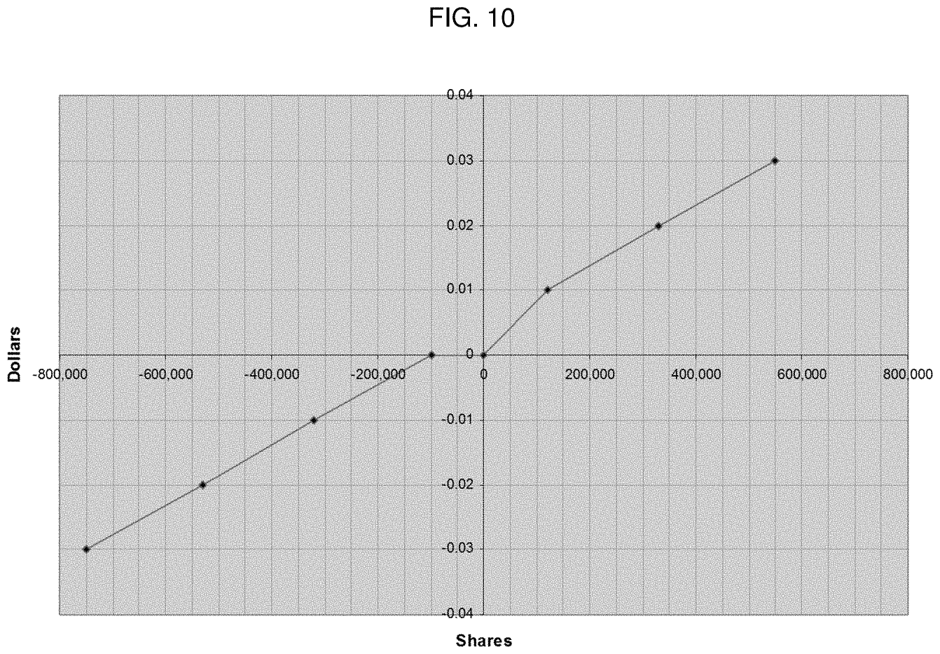

The graph of FIG. 10 shows the first few steps of the ladder of FIG. 9. As shown in FIG. 10, the spread is zero up to +100,000 shares, denoting CCA's willingness to trade at the mid-point to get back into balance.

Additional Features

### Accepting Order Flow and Retail Orders

In some embodiments, the fund may accept one or more orders from other traders. For example, the fund may accept one or more orders from or associated with another financial entity, such as all or a portion of the financial entity's order flow, or all or a portion of retail orders associated with the entity. For example, the fund may accept all or a portion of orders from retail customers of Schwab (e.g., individual customers and/or businesses who trade on their own behalf using Schwab). In some embodiments, the fund may accept all or a portion of trades of a given type or that satisfy one or more parameters (e.g., orders from a particular type of trader such as individual customers of an entity, trades above or below a certain volume, a type of order such as a market order, limit order, only at best order, market on close order, and/or other order types). In some embodiments, the fund may accept order streams that satisfy certain parameters (e.g., 90% of orders satisfy certain order parameters, such as the order parameters discussed herein).

For example, in some embodiments, an index may accept all or a portion of a stream of retail orders associated with a financial entity. Prior to accepting the orders, the system may determine that one or more of the orders (or the stream of orders) satisfies one or more parameters. For example, the system may determine that 95% of the orders satisfy a maximum volume requirement and are from individual traders who are retail customers of Schwab. The fund may fill the buy orders from its own inventory, and may fill the sell orders by accepting the sold securities into its inventory. In some embodiments, the fund may act as a market maker in the sense that it is willing to buy and sell a given financial instrument, providing liquidity to the market.

In some embodiments, the fund may accept orders at one or more specific prices, e.g., for a given security. In some embodiments, the fund may accept buy and sell orders at a “current market price.” For example, if a current market price of IBM stock is $10.06, the fund may accept both buy and sell orders at 10.06. In some embodiments, the fund may charge a spread over market.

In some embodiments, the fund may also accept more favorable prices (wherein the fund sells the instrument at a price higher than its market price and buys at a price lower than the market price). In some embodiments, the fund may require a spread between the price at which it is willing to buy and the price at which it is willing to sell, like a traditional market maker that makes money on the spread (e.g., by buying slightly lower and selling slightly higher).

In some embodiments, the fund may comprise or be associated with a trading platform, such as the Aqua and/or eSpeed trading platform that enables market participants to submit orders, e.g., anonymously. In some embodiments, the trading platform may earn revenue for enabling users to trade on the platform, e.g., by charging a transaction fee for each trade on the platform. In some embodiments, the fund may comprise the trading platform (or the trading platform may comprise the fund), and the fund may collect all or a portion of revenue for trades that occur on the platform. In some embodiments, the fund may collect revenue for trades in which the fund is a buyer or seller in the transaction. For example, the fund may collect all or a portion of a transaction fee paid by the counterparty for using the trading platform. Accordingly, in some embodiments, the fund may earn revenue each time it accepts an order, e.g., an order in the retail flow.

In some embodiments, for orders respecting a particular financial instrument, the fund may apply a spread (above or below a middle “market price”) that is narrower than a spread charged by a traditional market maker. In some embodiments, the fund may earn revenue based on transaction fees rather than (or in addition to) revenue resulting from filling trades according to a spread. Because the fund is earning transaction fees, it may not rely as much (or at all) on spread revenue. In this way, market participants can trade at a more favorable price (e.g., a price closer to the midpoint market price) than they would trade with a traditional market maker who relies on the spread for revenue.

In some embodiments, the fund may simply accept all orders (e.g., market orders) that satisfy certain parameters, e.g., provided that it can fill the orders from its own portfolio and trade account.

In some embodiments, the system may determine prices at which the fund is willing to accept orders for each financial instrument based on one or more factors, such as the amount of revenue it will receive for the transaction. As described above, the system may alternately or additionally determine prices based on the extent to which the transaction would cause the fund to deviate from its target (e.g., tracking error). For example, the system may accept or reject an order based on whether the transaction is likely to profit the fund in the long term, taking into account transaction fees, spread (if any), tracking error, and/or other factors.

In some embodiments, the parameters of acceptable orders may comprise the extent to which the orders (or stream) is likely to create significant deviation from the fund's target composition. For example, if the stream of orders is likely to be the financial equivalent of random noise (e.g., orders that do not fit a clear pattern that would tend to deviate the fund substantially (e.g., more than 1%) from its target composition), then the fund may accept those orders. In some embodiments, the fund may not accept orders, orders streams, or orders from particular traders if such orders may be likely, in the long run, to cause significant deviation from the fund's target composition. For example, the fund may not accept prop trading, or orders or order streams from prop traders.

In some embodiments, the system may calculate acceptable prices dynamically, e.g., based at least in part on changes in the fund's portfolio. For example, as the fund gets progressively heavier in a particular asset or asset class (e.g., 51% or more of Google stock) as compared to its target (e.g., 50% Google), then it may price a higher price premium for trades of Google stock (e.g., it may charge a larger spread or charge a higher premium for any transactions that would increase the fund's holdings of Google stock). In some embodiments, the system may charge a fixed spread (or no spread) until various parameters are satisfied, e.g., when the fund's holdings deviate from its target in a specific asset or asset class by a certain amount (e.g., 1%).

### Mutual Fund Redemptions

In some situations, when a mutual fund (or other entity) receives a request for a redemption (e.g., from an investor cashing out some of their shares of the mutual fund), the mutual fund may sell a slice of itself to raise cash to pay out the redemption. This typically causes the mutual fund to have to sell financial instruments held by the mutual fund. In some situations, the investor may receive a fair value for the redemption, but the mutual fund may incur transaction costs and other liabilities. Accordingly, the mutual fund may incur liabilities for the current holders (e.g., other investors owning the mutual fund).

In some embodiments, the system/fund may price a transaction involving a third party mutual fund redemption using the systems and methods described herein. When an entity such as a mutual fund seeks to sell or redeem one or more shares or other portion of ownership in the mutual fund (e.g., a “redemption portion”), the system/fund may finance the redemption transaction at a small discount from market price, e.g., by purchasing or renting the redemption portion (or a financial instrument related to or equivalent to the redemption portion). The transaction could be priced such that it is cheaper to the mutual fund (or other entity) to sell or lease the redemption portion (or equivalent) to the fund than it is to sell to the market to redeem the redemption portion, which can incur additional transaction costs and other liabilities and adverse consequences.

Later, when another investor (such as a new investor) adds money to the mutual fund, the mutual fund often re-acquires assets similar or identical to what was sold during the redemption, e.g., in circumstances where the mutual fund seeks to maintain a target composition of assets (and/or liabilities). According to various embodiments, when the mutual fund seeks to purchase or re-acquire assets similar or identical to what was sold (or rented), the system/fund can simply sell or rent back to the mutual fund all or a portion of the purchased or rented “redemption portion” held by the system/fund. In this way, an entity such as a mutual fund may constantly redeem and acquire as investors get into and out of the fund. In some embodiments, the system/fund may charge the mutual fund a holding fee or redemption fee for enabling this redemption/re-acquisition service.

In some embodiments, the fund may sell the redemption portion, e.g., on the market, e.g., at market price. For example, if the redemption portion of a mutual fund included 20 shares of Microsoft and 5 Coke bonds, the fund could simply sell those assets on the open market.

In some embodiments, the system could hold the redemption portion (or financial equivalent) for some period of time. In some embodiments, the system may simply own the redemption portion outright, free and clear from any obligations to the entity (e.g., mutual fund). In other embodiments, the system could allow the entity/mutual fund to take the redemption portion back, e.g., within a predetermined period of time (e.g., such that the system effectively receives “rent” for holding onto the redemption portion or financial equivalent). In some embodiments, the system can sell the redemption portion (or equivalent) back to the mutual fund at the purchase price or another price, such as a price determined based on one or more factors such as an original price (e.g., when the system/fund acquired the redemption portion from the mutual fund or other entity), change in value or effective market price of the redemption portion during the holding period, system/fund's incurred deviation from system/fund's target composition, time held (e.g., a “rental” price for holding an asset of a particular value for a particular time), and other factors.

For example, the fund may sell the redemption portion (or a portion thereof) back to the mutual fund if a new investor buys into the mutual fund and the mutual fund wants to re-acquire a portfolio (or portion thereof) similar or identical to the redemption portion. In this way, the fund may act as a sort of “renter” or “bank” for the mutual fund as it redeems and re-adds to its portfolio, with a minimum of transaction costs and tax liabilities.

In some embodiments, whenever the fund deviates from its target composition (e.g., by accepting mutual fund redemptions), the fund may engage in transactions to mitigate the deviation as discussed herein (e.g., by buying or selling correlated or inversely correlated assets, or by changing the prices it is willing to trade its own assets and non-owned correlated assets that would reduce effective tracking error and other risk factors). For example, if the fund buys 20 shares of Microsoft from the mutual fund during a redemption, then the fund can sell shares of IBM (correlated to Microsoft) to offset the risk of deviating from its target composition by having too much Microsoft or too much tech company stock.

### Trade Types Such as Market on Close

At the end of the trading day, an exchange or trading platform such as the NYSE may have an imbalance of orders for a particular financial instrument, e.g., more sell orders than buy orders for the financial instrument (or vice versa). The orders may be “market on close” orders that are filled at the end of the trading day. In some embodiments, the fund may agree to accept the imbalance of orders under various conditions, e.g., if various parameters are satisfied. For example, the fund may accept the imbalanced portion at a spread price (e.g., a price premium above or below a middle market price). In some embodiments, the fund may accept the orders (e.g., conditionally) based on whether they improve the fund's risk profile (e.g., reduce deviations from a target). In some embodiments, the fund may enter into all orders remaining at the end of a trading day as a way to reduce its risk (e.g., tracking risk). The fund may choose which Market On Close orders to enter into based on if the imbalance will help the fund's risk or hurt the fund's risk.

In some embodiments, the fund may have a prior arrangement with the exchange to fill all or a portion of such imbalanced orders. For example, the exchange such as the NYSE may determine an imbalance of buy orders for Google, determine that the fund has sufficient Google stock to cover the imbalanced portion of orders, and then execute a trade for the imbalanced orders with the fund as a counterparty.

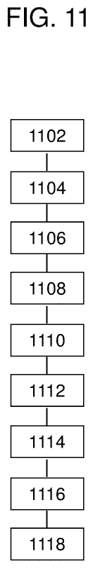

FIG. 11 depicts a flow diagram for according to at least one embodiment of the methods disclosed herein.

In block 1102, the processor determines a market price for buying a redemption portion of an investment fund, such as a mutual fund, e.g., as described herein. The redemption portion may comprise a portion of an investment fund that belongs to an investor who desires to liquidate all or a portion of the investor's investment in the investment fund. For example, a party who invested in a mutual fund may wish to redeem all or a portion of the party's investment in the mutual fund.

In block 1104, the processor determines a risk deviation to the market price based on a risk associated with buying the redemption portion of the first financial instrument, e.g., as described herein.

In block 1106, the processor determines a cost of unwinding the first order, and of holding the first order position during a time it takes to unwind.

The risk deviation may comprise a compensation to a buyer of the first financial instrument for taking on a risk of owning the first quantity of the first financial instrument, e.g., as described herein.

In block 1108, the processor determines a hedged risk deviation to the market price based on a combined risk associated with (1) buying the first quantity of the first financial instrument and (2) engaging in one or more transactions that hedge against owning the first quantity of the first financial instrument, e.g., as described herein.

In block 1110, the processor determines an adjusted price for buying the first quantity of the first financial instrument based on the market price, the risk deviation, and the hedged risk deviation. The adjusted price comprises the market price adjusted by an amount between (1) the risk deviation and (2) the hedged risk deviation, e.g., as described herein.

In block 1112, the processor transmits a first order to buy the first quantity of the first financial instrument at the adjusted price, e.g., as described herein.

In block 1114, the processor receives an indication of a first execution of the first order, e.g., as described herein.

In block 1116, the processor determines a plurality of orders to buy or sell second securities that, if accepted, would hedge against the buying of the first quantity of the first financial instrument, e.g., as described herein.

In block 1118, after receiving the indication of the first execution of the first order, the processor transmits a plurality of hedging orders to a plurality of users, e.g., as described herein.

### CCA Embodiment for Fixed Income.

Large holders of fixed income may be long in their bonds, and may have no real preference whether they hold Ford bonds of one cusip or Fond bonds of another cusip. However, the market for a particular cusip may be fairly illiquid. According to some embodiments, the system may make a market more liquid (e.g., by submitting buy and sell orders to the market, e.g., at a zero or non-zero spread) and give the large bond holders a nice profit on a bid-offer spread by accepting all offers and bids based on the principles described herein.

Large holders get discounts on their bonds (e.g., because they buy in bulk). The buy side funds can offer a bid-offer spread to the sell side. Large holders will take all orders to buy or sell, and make the spread. In some embodiments, the system (e.g., CCA) can determine buy and sell prices for the large bondholders to make the market, or the system can make the market itself.

In some embodiments, the pricing algorithms described herein need not involve tracking error. Rather, the pricing algorithm may be generic to all large players (e.g., large funds that may use their large size to accept bids and offers according to various embodiments described herein). Large players may have their own pricing algorithms So final pricing algorithm can calculate the system's price according to one or more pricing algorithms described herein, and then verify that the price is also approved by the large player's/client's pricing algorithm. In some embodiments, the system may facilitate the execution of trades by such large players at prices that are “approved” by the system's and large player's pricing algorithm. In some embodiments, the system may facilitate transactions of the type described herein (e.g., for a large player client instead of for the system's own fund) at other prices, e.g., a price between the system-calculated price and the large fund-calculated price (or a weighted average of the two prices), or at the system calculated price.

Many dealers no longer carry inventory, so they don't own things to sell clients and don't have capital to pay clients. Buy side/market makers can get special privileges (e.g., on pricing due to their size), but such buy side/market makers are not broker dealers with no position, but rather are long in their vast holdings.

In some embodiments, this may be marketed as a return enhancement. In some embodiments, this strategy could earn 10-20 basis points per turn. In some embodiments, the system or a participating fund may be willing to sell everything in its portfolio all the time.

In some embodiments, when calculating the premium to charge for a trade, an algorithm may strike a balance between:
1) The cost of trading out of the position
2) The risk of holding a position during the time it takes to trade out of it

(Exemplary mathematics and further description of various embodiments utilizing these principles are described further in Appendix I, incorporated herein by reference in its entirety.)

What if the system had multiple CCA's (or multiple sources of price ladders) trying to submit their own ladders into the market? The presence of the other ladder might affect CCA's ladder. The system's price may depend on tracking error and market movement risk. Tracking error may not depend on others, only the system's portfolio. But market movement is a function of the other quantity that might move in the market. Instead of recalibrating our ladder based on every order that comes into the market, the system can simply link our ladder prices to the total amount traded rather than the amount traded with CCA specifically. So if the system's price is mid+1 for 100k and mid+2 for 200k, the system may charge the 200k price if the buyer buys 200k, even if they only bought 100k from the system.

In some embodiments, the system's pricing algorithm may be based on two factors:
(1) market impact cost, e.g., the expected change in price after transaction. In some embodiments, market impact cost may be determined as a non-linear function that decreases with holding period (e.g., the amount of time the stock is held by the system) and may be based on the size of the order, the average daily volume, and/or volatility.
(2) Tracking error. Tracking error may be determined as a linear function that increases with holding period.

In some embodiments, the pricing algorithm may involve determining optimal holding period where the market impact curve intersects the tracking error line. Using this holding period, solve for market impact cost and tracking error, and determine the price CCA is willing to buy and sell with different quantities.

The holding period is more of a “maximum holding period”, as it is perfectly fine to dump the stock earlier given the right opportunity, which would reduce both market impact cost and tracking error.

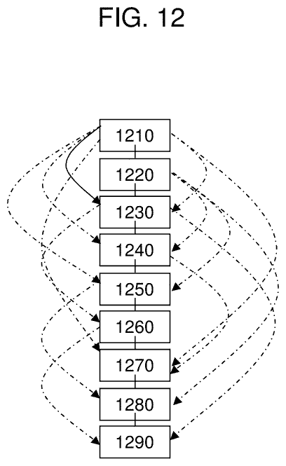

FIG. 12 depicts a flow diagram according to at least one embodiment of the methods disclosed herein.

The flow chart of FIG. 12 depicts an exemplary process whereby one or more quotes (e.g., prices for potential trades) may be provided to client traders by a pricing module on behalf of a pricing entity, such as a fund. As described below, a trader may request a quote for one or more possible trades. The trades may comprise possible trades with the pricing entity as a counter-party. A pricing module associated with the pricing entity may determine and output a requested quote to the requesting trader. The quote may comprise a quote for one or more trading products. In some embodiments, the quote may comprise a quote for a plurality of trades (e.g., a plurality of trades for a plurality of quantities for a plurality of different trading products). In this way, the quote may comprise a quote for a composite order comprising a basket of trades considered collectively (e.g., wherein executing the quote comprises executing multiple different trades to fulfill all constituent orders of a composite order). The quote may comprise a firm quote that is immediately executable against the pricing entity (e.g., one or more immediately executable trades between the requesting trader and the pricing entity).

The pricing module may be located behind a firewall of the trader. As such, quotes may be requested, processed, and output behind the firewall of the requesting trader without ever notifying the actual pricing entity of the quote or the existence of the request. The pricing module may determine prices on behalf of the pricing entity based on factors such as market conditions and the composition of the pricing entity's portfolio (e.g., if the pricing entity is a fund, e.g., a tracking fund that targets an index such as the S&P 500). For example, the pricing module may determine prices for the pricing entity based in part on tracking error that would result if the pricing entity actually executed the quoted trade. The pricing module may be updated as relevant pricing information changes, e.g., as market conditions change and as the composition of the fund (which impacts tracking error) changes.

In block 1210, information relating to a pricing module may be transmitted, e.g., to one or more traders. The information may be received and processed by a pricing module, e.g., located at one or more trader workstations. The pricing module may comprise a program and/or algorithm that determines quotes for possible trades with a specific pricing entity, e.g., an entity associated with a fund or portfolio. In effect, the pricing module may comprise a quote-generating computer program that acts as a local client-side agent for the pricing entity.

The pricing module may comprise a modified version of the “Go Fish” Aqua pricing module described in applications incorporated by reference herein. The pricing module may be configured to provide to the respective trader requested quotes for possible trades of one or more quantities of one or more trading products with the pricing entity or other counterparty(ies). The quotes may be firm and immediately executable, e.g., without requiring any further confirmation from the pricing entity (or other counterparty(ies)) before execution.

In some embodiments, the pricing modules at each trader workstation may be identical, such that they would produce identical quotes for identical trade queries submitted at the same time. Identical information may be transmitted to a plurality of different trader workstations. The information and/or the pricing module may be stored behind a firewall of each trader.

In some embodiments, the pricing module may be configured to calculate prices based on one or more pricing criteria related to a portfolio of a pricing entity such as a fund entity. For example, the pricing module may be configured to calculate quotes for a specified one or more possible trades based in part on tracking error (e.g., on the pricing entity's portfolio) that would result from filling the one or more trades (e.g., as described herein).

In some embodiments, the pricing module may be configured to determine prices for a quote based on net tracking error for a plurality of requested trades in a single quote. As described herein, a quote may be calculated based on a current market price (e.g., current NBBO or other price measure) for each trading product of interest as well as criteria such as the extent to which executing the trade would cause the fund of the pricing entity to deviate from an intended target.

In some embodiments, the tracking error for a single trade may be determined to be greater than the net tracking error for a plurality of trades comprising one or more trades that would offset the tracking error of one or more other trades. For example, the net tracking error for a quote to buy Chevron stock and sell Exxon stock may be less than the tracking error to simply buy Chevron, since the tracking error resulting from buying Chevron may at least partially offset the tracking error that would result from selling Exxon.

In block 1220, the portfolio of the pricing entity may change. For example, one or more assets may be added to or subtracted from a fund of the pricing entity, e.g., as a result of the pricing entity executing trades with one or more traders. For example, the pricing entity may add 200 shares of Google stock to its portfolio/fund and subtract 300 shares of Apple stock from its fund.

In block 1230, the pricing module at one or more trader workstations may be updated, e.g., based on changes in market conditions and changes in the portfolio of the pricing entity. In some embodiments, each pricing module may be updated (e.g., continually or periodically) as the portfolio and market conditions change. Since prices determined by the pricing module may depend in part on market prices and the composition of the pricing entity's fund, the quotes determined by the pricing module may change as the pricing module is updated to reflect current market conditions and the current composition of the fund. For example, if the portfolio already has more Google stock than its ideal target percentage of tech stocks, then the tracking error may be calculated to be higher for each additional purchase of Google stock by the pricing entity, which could negatively impact the price offered to traders who wish to sell Google stock to the pricing entity.

In block 1240, one or more traders may each request one or more quotes. For example, a single trader may request a quote (e.g., a price quote) for trading one or more trading products. For example, the request may comprise a request for a quote for a composite order comprising a “basket” or plurality of constituent trading orders. The requested “basket quote” may comprise a plurality of orders for a plurality of quantities of a plurality of different trading products, such as a request for a quote for (1) an order to buy 100 shares of IBM stock and (2) an order to sell 200 shares of Microsoft stock, wherein the two orders are considered together as a single composite order that would be executed together simultaneously (or substantially simultaneously).

In some embodiments, the pricing entity and/or central server may not be notified that a price quote was requested.

In block 1250, the respective pricing modules of the traders may determine and provide the various requested price quotes. Each quote may be requested, determined, and provided behind each trader's respective firewall, such that no other entity besides the individual trader is notified of the quote or the existence of the request. Each quote may comprise a firm, immediately executable quote.

In some embodiments, the pricing modules at different trader workstations may use the same data and algorithms, and thus may be configured to produce identical quotes for identical quote inquiries. For example, at a given time, a quote provided for a composite/basket order comprising (1) an order to buy 100 shares of IBM stock and (2) an order to sell 200 shares of Microsoft stock may be priced the same regardless of which trader workstation prices the quote. In other embodiments, quotes may be priced differently for different trader workstations. For example, pricing modules at workstations of favored traders may produce more favorable prices (for the favored trader) than pricing modules at other trader workstations.

In block 1260, the pricing module of each trader may be updated, e.g., based on changing market conditions, changes to the pricing entity's fund (e.g., changing tracking error), and other changes that may impact pricing of quotes. In some embodiments, update information may be pushed from a processor (such as a workstation of the pricing entity) to each pricing module of each trader. In some embodiments, each pricing module may actively monitor pricing-related information such as fund composition of the pricing entity and current market prices.

In block 1270, the pricing module may modify outstanding quotes. For example, in some embodiments, an outstanding quote may be modified and/or otherwise updated, e.g., automatically, if pricing criteria change while the quote is pending (e.g., if the pricing module is updated to reflect changing market conditions and/or changing tracking error). For example, an outstanding quote to buy Microsoft stock at $256/share may automatically change to $257/share, e.g., if the pricing module determines that the market price of Microsoft has increased by $1 since the original quote was provided.

In block 1280, a trader may request to execute a quoted trade(s). For example, the user may issue an “execute” command (e.g., by selecting an “execute” button on a user interface), which causes the quoted trade(s) to be executed. For a composite order comprising a plurality of trades included in the quote, the plurality of trades may be executed, e.g., simultaneously or substantially simultaneously. The trades may be executed with requesting trader as one party and the pricing entity as the counterparty. For example, the trader may buy a portion of the pricing entity's portfolio/fund, and the trader may one or more trading products to the pricing entity.

In block 1290, the pricing entity may be notified of the trade(s). The pricing modules may be updated, e.g., to reflect the changed composition of the pricing entity's fund (which impacts tracking error). In some embodiments, the pricing entity may not be notified of the trade(s) until the time of the actual trade (e.g., simultaneous with the execution of the trade, or after the trade is executed).

It should be appreciated that in some embodiments, information about two (or more) different traders' quotes may not be provided outside its firewall. In other embodiments, information about each trader's quote requests may be provided to the pricing modules of other traders. The pricing modules may then determine a “firm quote” as well as a “conditional quote” that is priced according to the collective execution of the first trader's orders and a second trader's orders (and the collective tracking error of both sets of trades, which may be less than tracking error of the two sets of trades considered individually). Thus, a better price may be conditioned on the second trader also executing against his quote. In some embodiments, all information about the second (or third etc.) quote, including the identity of the second (and third) trader and the trading products at issue, may be kept confidential.

It should further be appreciated that a plurality of different funds may provide quotes to each trader (e.g., each with different prices due to different tracking error). The prices may be determined by one or more pricing modules at each trader's workstation.

It should be appreciated that the actions described in the blocks for the methods described herein are exemplary only, and need not be performed in the order presented here. Further, it is not necessary to accomplish all of the actions described in the blocks. Rather, any number of the blocks (e.g., four of the blocks or six of the blocks) may be accomplished, and in any order. Further, the actions described herein may be combined with any other actions described herein, in any order.

The features described herein may be configured to operate within the trading systems described in U.S. patent application Ser. No. 12/477,549, filed Jun. 3, 2009, entitled “PRODUCTS AND PROCESSES FOR GENERATING A PLURALITY OF ORDERS” and U.S. Ser. No. 12/477,523 filed Jun. 3, 2009, such as the order management systems (e.g., the “OMS”) described therein.

It should be understood that each of the features described herein may also be configured to operate within the trading systems described in U.S. Ser. No. 12/470,431 filed May 21, 2009; U.S. patent application Ser. No. 12/135,479, filed Jun. 9, 2008, entitled “TRADING SYSTEM PRODUCTS AND PROCESSES”; U.S. patent application Ser. No. 12/113,602, filed May 1, 2008, entitled “ELECTRONIC SECURITIES MARKETPLACE HAVING INTEGRATION WITH ORDER MANAGEMENT SYSTEMS”; U.S. patent application Ser. No. 12/237,976, filed Sep. 25, 2008, entitled “TRADING RELATED TO FUND COMPOSITIONS”; U.S. application Ser. No. 13/234,147, filed Sep. 15, 2011; U.S. Provisional Patent Application Ser. No. 61/513,667, filed Jul. 31, 2011, entitled “SYSTEMS AND METHODS FOR PRICING ORDERS;” U.S. Provisional Patent Application Ser. No. 61/383,081, filed Sep. 15, 2010, entitled “SYSTEMS AND METHODS FOR ORDER PRICING;” U.S. Provisional Patent Application Ser. No. 61/612,958, filed Mar. 19, 2012, entitled “ORDER PRICING BASED ON MARKET IMPACT;” and U.S. Provisional Patent Application Ser. No. 61/614,245, filed Mar. 22, 2012, entitled “ORDER PRICING BASED ON MARKET IMPACT.”

In addition, in various additional embodiments, each of the features described herein may also be configured to operate within the trading systems described in U.S. patent application Ser. No. 10/310,345 (U.S. Patent Publication No. 2004/0034591).

The disclosures of the above-identified applications, and all other patent applications and other documents referenced in this patent application, are incorporated by reference herein in their entireties.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. (canceled)

2. A method comprising:
receiving, by a first of a plurality of computing devices of a corresponding first of a plurality of traders, first information about a portfolio of a pricing entity;
receiving, by a graphical user interface of the first computing device, a request for a quote for transacting a plurality of different trading products, the request comprising a plurality of orders, each order defining a trading product, a respective quantity of the respective trading product, and a buy/sell side of the first trader;
responsive to the request for a quote, determining, by the first computing device, a first quote for transacting all of the plurality of orders of the first trader based on the received information about the portfolio of the pricing entity, the first quote being a firm quote that is immediately executable against the pricing entity;
communicating, by the graphical user interface of the first computing device, the first quote to the first trader;
receiving, by a button of the graphical user interface of the first computing device, a request to execute the first quote, in which the pricing entity does not receive any information indicating the existence of the request for quote or the first quote before the request to execute the first quote is received; and
responsive to the request to execute, causing a plurality of trades to be transacted between the first trader and the pricing entity such that the plurality of orders of the first trader are filled by the pricing entity,
in which the request for quote is received behind a firewall of the first trader, the first quote is determined behind the firewall, and the first quote is communicated to the first trader behind the firewall such that the first quote and the existence of the request for quote is not transmitted to the pricing entity before any execution of the quote,
in which the first quote is determined by a pricing module stored behind a firewall of the first trader, wherein the pricing module is configured to determine prices at which the pricing entity will execute trades with the first trader; and
in which the pricing module is encrypted such that information about requests for quotes are kept confidential from the pricing entity even though the quotes are binding on the pricing entity.

3. The method of claim 2, in which the act of determining the quote comprises determining a net tracking error on the portfolio of the pricing entity that would result if the pricing entity filled the plurality of orders.

4. The method of claim 3, in which the act of determining a net tracking error comprises determining a first tracking error that would result if the pricing entity filled a first of the plurality of orders and a second tracking error that would result if the pricing entity filled a second of the plurality of orders, wherein the first tracking error and the second tracking error at least partially offset one another.

5. The method of claim 2, in which the quote comprises a firm quote for transacting all of the plurality of orders.

6. The method of claim 2, in which the quote comprises a plurality of prices for the plurality of orders.

7. The method of claim 2, in which the quote comprises a net price that would be transferred between the first trader and pricing entity in order to execute the plurality of orders.

8. The method of claim 2, in which the plurality of trades changes the portfolio of the pricing entity, further comprising:
after the plurality of orders are filled, receiving, by the first computing device, updated information about the portfolio of the pricing entity reflecting the plurality of trades.

9. The method of claim 7, further comprising:
after receiving updated information about the portfolio of the pricing entity, receiving a second request for a second quote;
responsive to receiving the second request for the second quote, determining the second quote based in part on the updated information.

10. An apparatus, comprising:
at least one processor; and
at least one memory, in electronic communication with the at least one processor, having instructions stored thereon which, when executed by the at least one processor, direct the at least one processor to:
receive, by a first of a plurality of computing devices of a corresponding first of a plurality of traders, first information about a portfolio of a pricing entity;
receive, by a graphical user interface of the first computing device, a request for a quote for transacting a plurality of different trading products of the first trader, the request comprising a plurality of orders, each order defining a trading product, a respective quantity of the respective trading product, and a buy/sell side of the first trader;
responsive to the request for a quote, determine, by the first computing device, a first quote for transacting all of the plurality of orders of the first trader based on the received information about the portfolio of the pricing entity, the first quote being a firm quote that is immediately executable against the pricing entity;
communicate, by the graphical user interface of the first computing device, the first quote to the first trader;
receive, by a button of the graphical user interface of the first computing device, a request to execute the first quote, in which the pricing entity does not receive any information indicating the existence of the request for quote or the first quote before the request to execute the first quote is received; and
responsive to the request to execute, cause a plurality of trades to be transacted between the first trader and the pricing entity such that the plurality of orders of the first trader are filled by the pricing entity,
in which the request for quote is received behind a firewall of the first trader, the first quote is determined behind the firewall, and the first quote is communicated to the first trader behind the firewall such that the first quote and the existence of the request for quote is not transmitted to the pricing entity before any execution of the quote,
in which the first quote is determined by a pricing module stored behind a firewall of the first trader, wherein the pricing module is configured to determine prices at which the pricing entity will execute trades with the first trader; and
in which the pricing module is encrypted such that information about requests for quotes are kept confidential from the pricing entity even though the quotes are binding on the pricing entity.

11. The apparatus of claim 10, in which the act of determining the quote comprises determining a net tracking error on the portfolio of the pricing entity that would result if the pricing entity filled the plurality of orders.

12. The apparatus of claim 11, in which the act of determining a net tracking error comprises determining a first tracking error that would result if the pricing entity filled a first of the plurality of orders and a second tracking error that would result if the pricing entity filled a second of the plurality of orders, wherein the first tracking error and the second tracking error at least partially offset one another.

13. The apparatus of claim 10, in which the quote comprises a firm quote for transacting all of the plurality of orders.

14. The apparatus of claim 10, in which the quote comprises a plurality of prices for the plurality of orders.

15. The apparatus of claim 10, in which the quote comprises a net price that would be transferred between the first trader and pricing entity in order to execute the plurality of orders.

16. The apparatus of claim 10, in which the plurality of trades changes the portfolio of the pricing entity, further comprising:
after the plurality of orders are filled, receiving, by the first computing device, updated information about the portfolio of the pricing entity reflecting the plurality of trades.

17. The apparatus of claim 16, in which the instructions, when executed by the at least one processor, further direct the at least one processor to:
after receiving updated information about the portfolio of the pricing entity, receiving a second request for a second quote;
responsive to receiving the second request for the second quote, determining the second quote based in part on the updated information.

18. A non-transitory machine-readable medium having instructions stored thereon that are configured to, when executed by the at least one processor, direct at least one processor to:
receive, by a first of a plurality of computing devices of a corresponding first of a plurality of traders, first information about a portfolio of a pricing entity;
receive, by a graphical user interface of the first computing device, a request for a quote for transacting a plurality of different trading products of the first trader, the request comprising a plurality of orders, each order defining a trading product, a respective quantity of the respective trading product, and a buy/sell side of the first trader;
responsive to the request for a quote, determine, by the first computing device, a first quote for transacting all of the plurality of orders of the first trader based on the received information about the portfolio of the pricing entity, the first quote being a firm quote that is immediately executable against the pricing entity;
communicate, by the graphical user interface of the first computing device, the first quote to the first trader;
receive, by a button of the graphical user interface of the first computing device, a request to execute the first quote, in which the pricing entity does not receive any information indicating the existence of the request for quote or the first quote before the request to execute the first quote is received; and
responsive to the request to execute, cause a plurality of trades to be transacted between the first trader and the pricing entity such that the plurality of orders of the first trader are filled by the pricing entity,
in which the request for quote is received behind a firewall of the first trader, the first quote is determined behind the firewall, and the first quote is communicated to the first trader behind the firewall such that the first quote and the existence of the request for quote is not transmitted to the pricing entity before any execution of the quote,
in which the first quote is determined by a pricing module stored behind a firewall of the first trader, wherein the pricing module is configured to determine prices at which the pricing entity will execute trades with the first trader; and
in which the pricing module is encrypted such that information about requests for quotes are kept confidential from the pricing entity even though the quotes are binding on the pricing entity.
